(19) United States
(12) Patent Application Publication
(10) Pub. No.: US 2008/0117455 A1
(43) Pub. Date: May 22, 2008

(54) APPARATUS FOR CONTROLLING PRINTING OF PART IMAGES OF SCRAPBOOK, METHOD OF CONTROLLING SAME, AND CONTROL PROGRAM THEREFOR

(75) Inventors: Masafumi Tomono, Ashigarakami-gun (JP); Meiji Itoh, Ashigarakami-gun (JP); Hiroshi Minatogawa, Tokyo (JP); Yuko Suzuki, Tokyo (JP); Karin Kon, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/944,190

(22) Filed: Nov. 21, 2007

(30) Foreign Application Priority Data
Nov. 22, 2006 (JP) 2006-315176

(51) Int. Cl. G06K 1/00

(52) U.S. Cl. 358/1.15

(57) ABSTRACT

Decorative images for creating a scrapbook are printed efficiently. To achieve this, a creator accesses a scrapbook server using a computer and executes a simulation for creating a scrapbook by affixing part images such as photographic images and decorative images to an image of a paper mount on the display screen of the computer. When a paper mount, photographs and decorative images, etc., for actually creating the scrapbook are printed on paper or the like by the creator him/herself, the decorative images are printed upon being arranged in order of decreasing area of rectangles that enclose the decorative images. The decorative images are placed and printed automatically in an efficient manner.

### BACKGROUND OF THE INVENTION

1. Field of the Invention

This invention relates to an apparatus for controlling the printing of part images of a scrapbook, a method of controlling this apparatus and a program for controlling the apparatus.

2. Description of the Related Art

There is a technique whereby a server is accessed to furnish a postcard with an image or decoration (see the specification of Japanese Patent Application Laid-Open No. 11-53521). With a technique of this kind, a template image is displayed on the computer of the user and the user performs an editing operation to decorate or embellish the template image. A desired number of copies of the edited postcard are printed and delivered to the residence of the user.

A postcard thus edited and completed is merely delivered to the residence of the user. This is different from an operation in which the user creates a postcard by actually affixing part images such as photographs, heart images and diamond images to a paper mount.

In a case where a user affixes a part image to a paper mount, the part image is printed as by a printer located at the residence of the user. If printing is not performed efficiently, paper will be wasted and ink for the printer will also be consumed wastefully.

### SUMMARY OF THE INVENTION

Accordingly, an object of the present invention is to print part images efficiently.

According to the present invention, the foregoing object is attained by providing an apparatus for controlling printing of part images of a scrapbook, comprising: a selecting device for selecting the image of a part of a scrapbook created by affixing a part such as a photograph to a part such as a paper mount; a display control device for controlling a display unit in such a manner that the part image selected by the selecting device is placed and displayed at a position designated by a user; a quit command input device for inputting a quit command to quit a scrapbook creating simulation carried out by repeating the selection of part images by the selecting device and the display of part images by the display control device; and a printer control device, which is responsive to input of the quit command from the quit command input device, for controlling a printer so as to print part images, which have been selected by the selecting device, close together on paper in such a manner that these part images will not overlap one another.

The present invention also provides a method of controlling an apparatus for controlling printing of part images of a scrapbook, the method comprising the steps of: selecting, by a selecting device, the image of a part of a scrapbook created by affixing a part such as a photograph to a part such as a paper mount; controlling, by a display control device, a display unit in such a manner that the part image selected by the selecting device is placed and displayed at a position designated by a user; inputting, by a quit command device, a quit command to quit a scrapbook creating simulation carried out by repeating the selection of part images and the display of selected part images; and in response to input of the quit command, controlling, by a printer control device, a printer so as to print part images, which have been selected by the selecting device, close together on paper in such a manner that these part images will not overlap one another.

The present invention further provides a program for implementing the method of controlling the apparatus for controlling the printing of part images of a scrapbook described above, and a recording medium on which this program has been stored.

In accordance with the present invention, a simulation for creating a scrapbook is performed. This involves repeating the selection of part images and the placement of the part images selected. When the simulation is finished, a quit command is input. In response to input of the quit command, the selected part images are printed on paper close together in such a manner that they will not overlap one another. The part images used in the creation of the scrapbook are printed efficiently in such a manner that wasted areas will not be produced on the paper.

By way of example, the printer control device may control the printer, in response to input of the quit command from the quit command input device, so as to print the part images upon deciding placement positions close together on the paper in such a manner that rectangles enclosing the part images that have been selected by the selecting device will not overlap one another, the placement positions being decided in order of decreasing size of the rectangles of the part images.

The printer control device may halt the printing of an overlap portion of an underlying part image placed and displayed below one part image that has been selected by the selecting device, or halt the printing of the interior of the overlap portion and print an outline. Since the portion printed is reduced, consumption of ink (toner) required for printing can be suppressed.

### BRIEF DESCRIPTION OF THE DRAWINGS

FIG. 1 illustrates an overview of a scrapbook order system;

FIG. 2 is a block diagram illustrating the electrical configuration of the scrapbook server;

FIGS. 3 to 6 are flowcharts illustrating processing executed between the computer of a creator and a scrapbook server;

FIGS. 7 to 12 illustrate examples of windows displayed on the display screen of a computer;

FIG. 13 illustrates an example of layer data;

FIG. 14 illustrates layer thickness information;

FIGS. 15A to 15E illustrate the manner in which layers are superimposed;

FIG. 16 illustrates thickness information concerning superimposed layers;

FIG. 17 is a flowchart illustrating thickness determination processing;

FIG. 18 illustrates an example of a window displayed on the display screen of a computer;

FIG. 19 is a flowchart illustrating processing for creating scrapbook data;

FIG. 20A illustrates two layers and FIG. 20B illustrates superimposed layers;

FIG. 21 is a flowchart illustrating overlap determination processing;

FIG. 22 is an example of a layer;

FIG. 23 is an example of a procedural manual;

FIGS. 24A to 24E illustrate an example of a pictorial procedural manual;

FIG. 25 is a flowchart illustrating processing for creating a pictorial procedural manual;

FIG. 26 is an example of a window displayed on the display screen of a computer;

FIG. 27 is a flowchart illustrating processing for setting an affiliate;

FIG. 28 is an example of a public page;

FIGS. 29 and 30 are flowcharts illustrating processing between a user computer and a scrapbook server;

FIG. 31 illustrates an example of a blog;

FIG. 32 is a flowchart illustrating processing between a user computer and a scrapbook server;

FIG. 33 illustrates the corresponding relationship between set affiliate content and points;

FIG. 34 is a flowchart illustrating point processing;

FIG. 35 is a flowchart illustrating a part of processing executed by the computer of a creator;

FIG. 36 is a flowchart illustrating a part of processing executed by the computer of a scrapbook server;

FIGS. 37 and 38 show examples of windows displayed on the display screen of a computer;

FIG. 39 illustrates the relationship between type of paper and a selected part image;

FIG. 40 shows an example of a window displayed on the display screen of a computer;

FIG. 41A illustrates an example of decorative images, and FIGS. 41B to 41D illustrate printed parts;

FIG. 42 is a flowchart illustrating automatic placement processing;

FIGS. 43 and 44 illustrate the placement position of a decorative image;

FIG. 45 illustrates decorative images and rectangles enclosing the decorative images;

FIGS. 46A and 46B illustrate decorative images positioned on paper;

FIG. 47 illustrates an example of a window displayed on the display screen of a computer;

FIG. 48 illustrates an example of a part;

FIGS. 49A to 49C illustrate examples of decorative images;

FIGS. 50A to 50C illustrate examples of parts;

FIG. 51 is a flowchart illustrating processing for printing a decorative image;

FIG. 52 is a flowchart illustrating processing for extracting an overlap portion;

FIG. 53 illustrates a paper-mount image and a decorative image; and

FIG. 54 illustrates the underside of a part.

### DESCRIPTION OF THE PREFERRED EMBODIMENTS

A preferred embodiment of the present invention will now be described in detail with reference to the accompanying drawings.

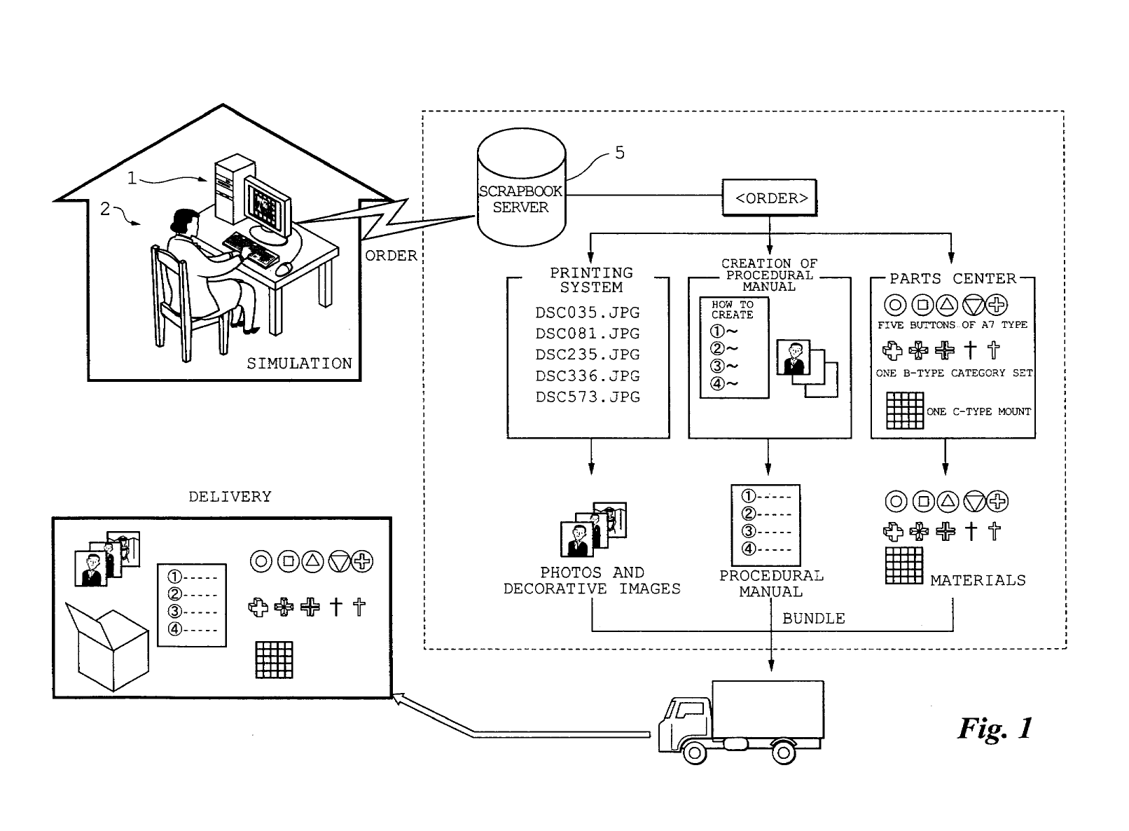

FIG. 1 illustrates an overview of a scrapbook order system according to a preferred embodiment of the present invention.

The scrapbook order system according to this embodiment is such that a creator 2 attempting to actually create a scrapbook is capable of executing a simulation for creating the scrapbook using the creator's own computer 1. The creator 2 accesses a scrapbook server 5 using the computer 1. When this is done, the scrapbook server 5 sends the computer 1 of the creator 2 part image data representing part images for executing the simulation of scrapbook creation. Examples of the part images are a paper mount image, photographic image, decorative images such as marks, and material images representing three-dimensional materials such as a ribbon or button.

Upon receiving the part image data, the computer 1 of the creator 2 executes the scrapbook creating simulation on the display screen on the computer 1 using the part images represented by the part image data. Whenever a part image is selected and the placement thereof decided, layer data is transmitted from the computer 1 of the creator 2 to the scrapbook server 5 in succession.

Upon receiving the layer data transmitted from the computer 1 of the creator 2, the scrapbook server 5 creates a procedural manual (an explanation manual for actually creating a scrapbook) in line with the simulation of the creator 2 based upon the received layer data. Further, photographs and decorative images necessary in order to create the scrapbook are printed, and material such as ribbons and buttons is extracted in a parts center. Parts such as the paper mount and photographs for creating the scrapbook and the procedural manual (explanation manual) for creating the scrapbook are packaged and the package is delivered to the residence of creator 2 from the scrapbook center.

While looking at the procedural manual and using the parts contained in the package, the creator 2 creates the scrapbook by affixing the photographs, printed decorative images and material such as ribbons and buttons to the mount in the manner that was carried out in the simulation.

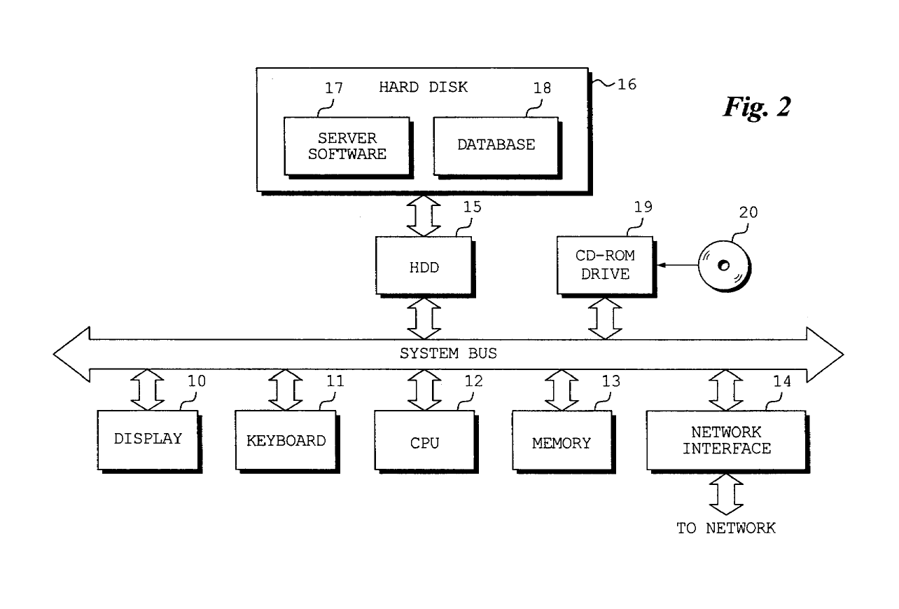

FIG. 2 is a block diagram illustrating the electrical configuration of the scrapbook server 5.

The operation of the overall scrapbook server 5 is controlled by a CPU 12.

The scrapbook server 5 includes a CD-ROM (Compact Disk-Read-Only Memory) drive 19. When a CD-ROM 20 on which server software 17 for controlling an operation (described later) has been stored is loaded in the CD-ROM drive 19, the server software 17 is installed on a hard disk 16. In addition to the server software 17, a database 18 has been stored on the hard disk 16. The server software 17, etc., stored on the hard disk 16 is accessed by a hard-disk drive 15.

The scrapbook server 5 includes a display unit 10 for displaying images, a keyboard 11 for inputting commands, etc., a memory 13 for storing data, etc., temporarily, and a network interface 14 for connecting to a network.

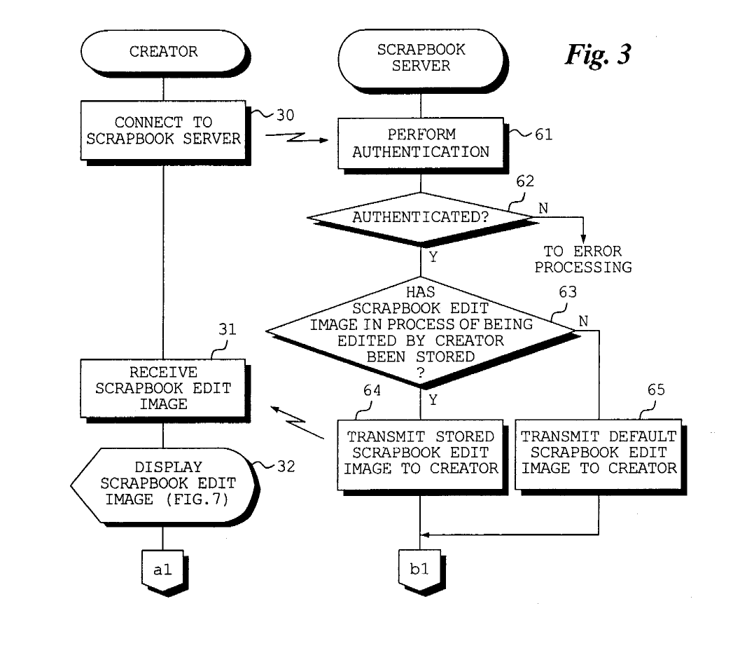

FIGS. 3 to 6 are flowcharts illustrating processing executed between the computer 1 of the creator 2 and the scrapbook server 5. These flowcharts show the processing of the simulation for creating a scrapbook in the manner described above.

The computer 1 of the creator 2 and the scrapbook server 5 are connected (step 30) and the creator 2 is authenticated at the scrapbook server 5 (step 61). When the creator has been authenticated (“YES” at step 62), the scrapbook server 5 determines whether a scrapbook edit image, namely an image whose editing by the creator 2 is in progress, has been stored (step 63).

An image displayed on the display screen of the computer 1 of the creator 2 in a simulation is a scrapbook edit image. During or after a simulation, data representing the scrapbook edit image can be stored in the scrapbook server 5, and a simulation can be carried out using the stored scrapbook edit image. Whether a scrapbook edit image has been stored or not is determined for this reason. If a scrapbook edit image has been stored (“YES” at step 63), the data representing the stored scrapbook edit image is transmitted from the scrapbook server 5 to the computer 1 of the creator 2 (step 64). If a scrapbook edit image has not been stored (“NO” at step 63), then data representing a default scrapbook edit image is transmitted from the scrapbook server 5 to the computer 1 of creator 2 (step 65).

Upon receiving data representing a scrapbook edit image (step 31), the computer 1 of the creator 2 displays the scrapbook edit image on the display screen of the computer 1 (step 32). In this embodiment, it is assumed that the default scrapbook edit image is displayed.

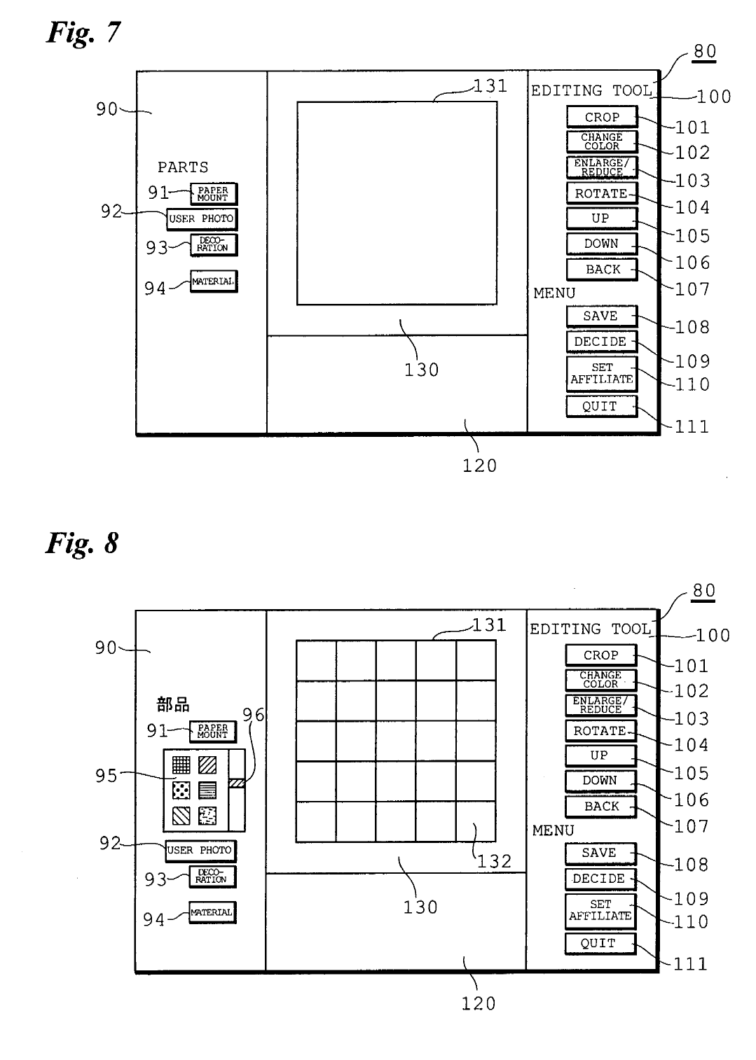

FIG. 7 illustrates an example of a window 80 displayed on the display screen of the computer 1 of creator 2.

The window 80 is formed to have a part selection area 90 on the left side, a command issuing area 100 on the right side, a part-color specifying area 120 at bottom center, and a scrapbook edit image display area 130 at the center.

The part selection area 90 includes a mount area 91, a user photo area 92, a decoration area 93 and a material area 94.

The mount area 91 is an area clicked by the creator if a paper mount is selected. If the mount area 91 is clicked, a small window 95 appears under the mount area 91, as illustrated in FIG. 8. Thumbnail mount images representing samples of paper mounts are displayed within the small window 95 that has appeared. A scroll bar 96 is formed on the right side of the small window 95. New thumbnail mount images appear in the small window 95 in response to the scroll bar 96 being moved up or down. Clicking a thumbnail mount image that is being displayed in the small window 95 selects the mount image.

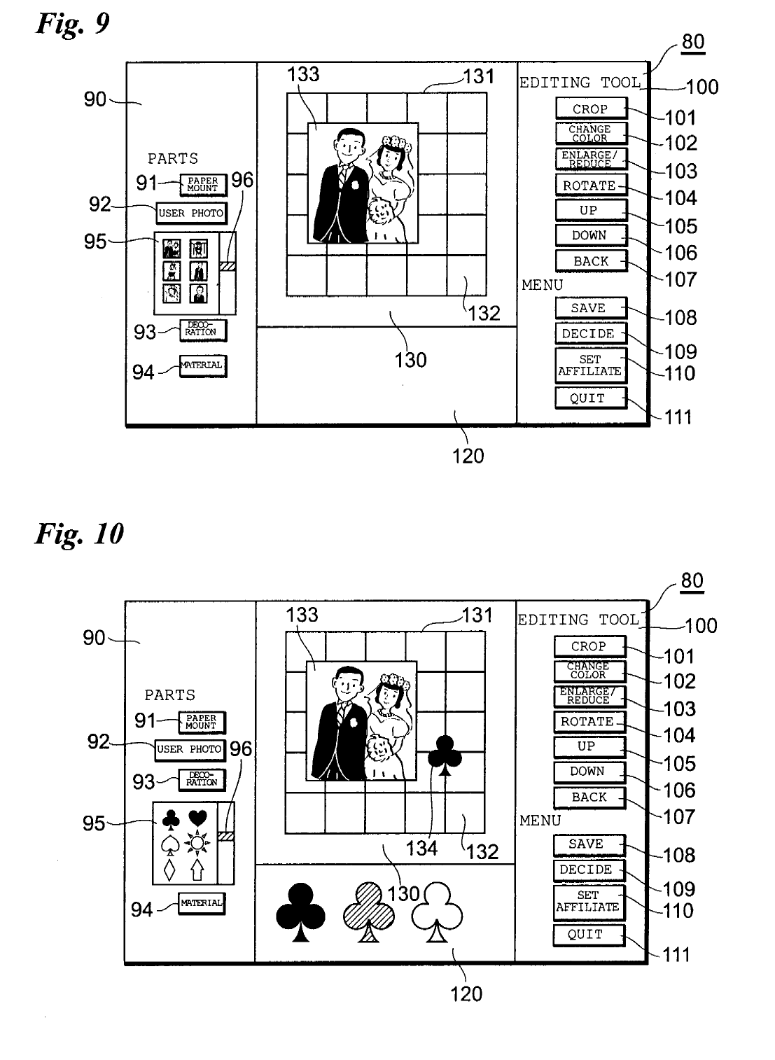

The user photo area 92 is an area clicked by the creator in a case where a photograph of the user (creator) is selected. If the user photo area 92 is clicked, the small window 95 appears under the user photo area 92, as illustrated in FIG. 9. Thumbnail images of user images are displayed in the small window 95 that has appeared. Clicking a thumbnail user image that is being displayed in the small window 95 selects the user photo.

The decoration area 93 is an area clicked by the creator in a case where a decorative image is selected. If the decoration area 93 is clicked, the small window 95 appears under the decoration area 93, as illustrated in FIG. 10. Thumbnail images of decorative images are displayed in the small window 95 that has appeared. Clicking a thumbnail decorative image being displayed in the small window 95 selects the decorative image.

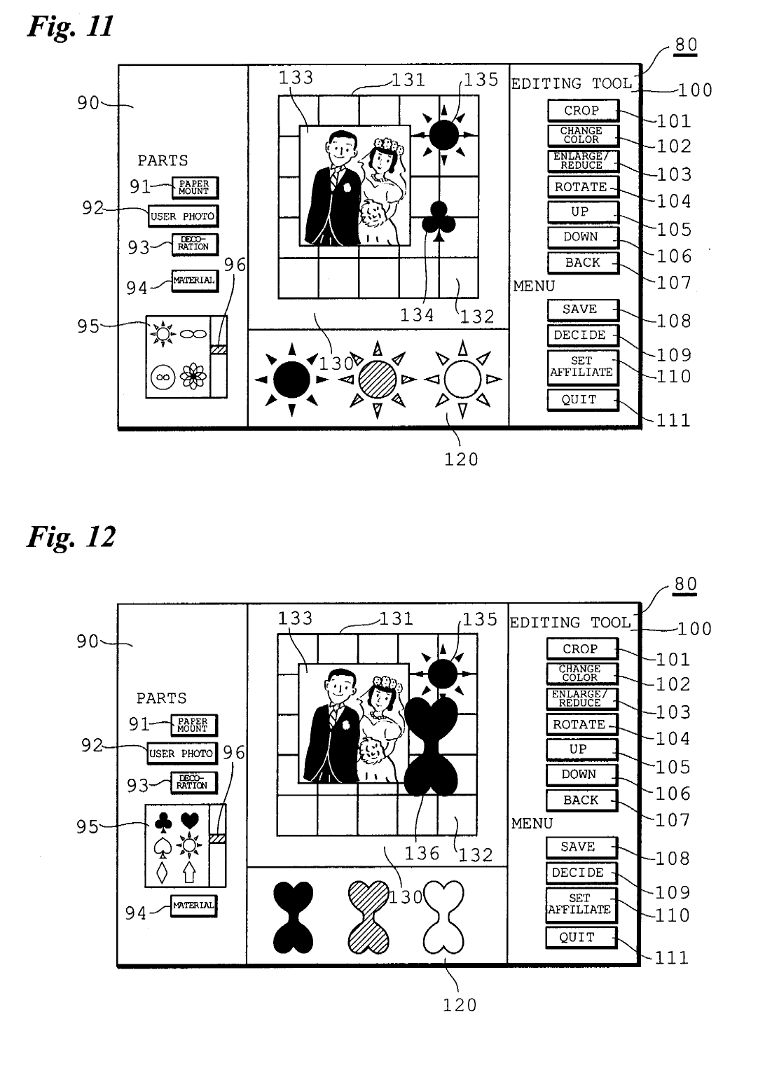

The material area 94 is an area clicked by the creator in a case where the user selects a decoration consisting of material having thickness, such as a button or ribbon, other than paper. If the material area 94 is clicked, the small window 95 appears under the material area 94, as illustrated in FIG. 11. Images of materials are displayed in the small window 95 that has appeared. Clicking a material image being displayed in the small window 95 selects the material.

The command issuing area 100 includes a crop area 101, a color-change area 102, an enlarge/reduce area 103, a rotate area 104, an UP area 105, a DOWN area 106, a BACK area 107, a save area 108, a decide area 109, an affiliate setting area 110 and a quit area 111.

The crop area 101 is an area clicked in a case where a portion of a part is cropped. A part image to be cropped is selected after the crop area 101 is clicked, and the portion to be cropped is designated by a cursor, thereby deciding the portion cropped. The color-change area 102 is an area clicked when a color is to be changed in a case where a plurality of colors are available for the same part. If a part image is selected after the color-change area 102 is clicked, the color of the selected part image changes. Naturally, it may be so arranged that a color pallet is displayed and a color designated from among the colors on the displayed color pallet. The enlarge/reduce area 103 is an area clicked in a case where a part image is enlarged or reduced in size. If a part image is selected after the enlarge/reduce area 103 is clicked, the selected part image is enlarged or reduced in size. It may be so arranged that an enlarge icon or reduce icon is displayed in order to specify enlargement or reduction.

The rotate area 104 is an area clicked in a case where a part image is rotated. By selecting a part image and dragging it after the rotate area 104 is clicked, the part image is rotated. The UP area 105 is clicked when a part image in a lower layer is made an upper layer. If a part image is clicked after the UP area 105 is clicked, this part image becomes one layer higher than the present layer. The DOWN area 106 is clicked when a part image in an upper layer is made a lower layer. If a part image is clicked after the DOWN area 106 is clicked, this part image becomes one layer lower than the present layer. The BACK area 107 restores the part image to the default. If a part image is selected after the BACK area 107 is clicked, the selected part image is restored to the default image.

The save area 108 is clicked when data representing a scrapbook image edited in the manner described above is stored in the scrapbook server 5. The decide area 109 is clicked whenever editing of a single part, such as selection, placement or color change, etc., of the part, is decided. The affiliate setting area 110 is clicked in a case where a third-party user utilizes a scrapbook edit image that has been created by the creator 2. The quit area 111 is clicked when editing is finished.

When a plurality of colors have been assigned to a selected part, parts having these plurality of colors are displayed in the part-color specifying area 120. The creator 2 selects the image of the part having the desired color from among the plurality of colors.

The scrapbook edit image display area 130 is an area in which a scrapbook edit image currently undergoing editing is displayed. If data representing a default scrapbook edit image is transmitted to the computer 1 of creator 2, as described above, a simple border 131 is displayed in the scrapbook edit image display area 130 in the manner illustrated in FIG. 7. The border 131 itself need not be displayed, as a matter of course.

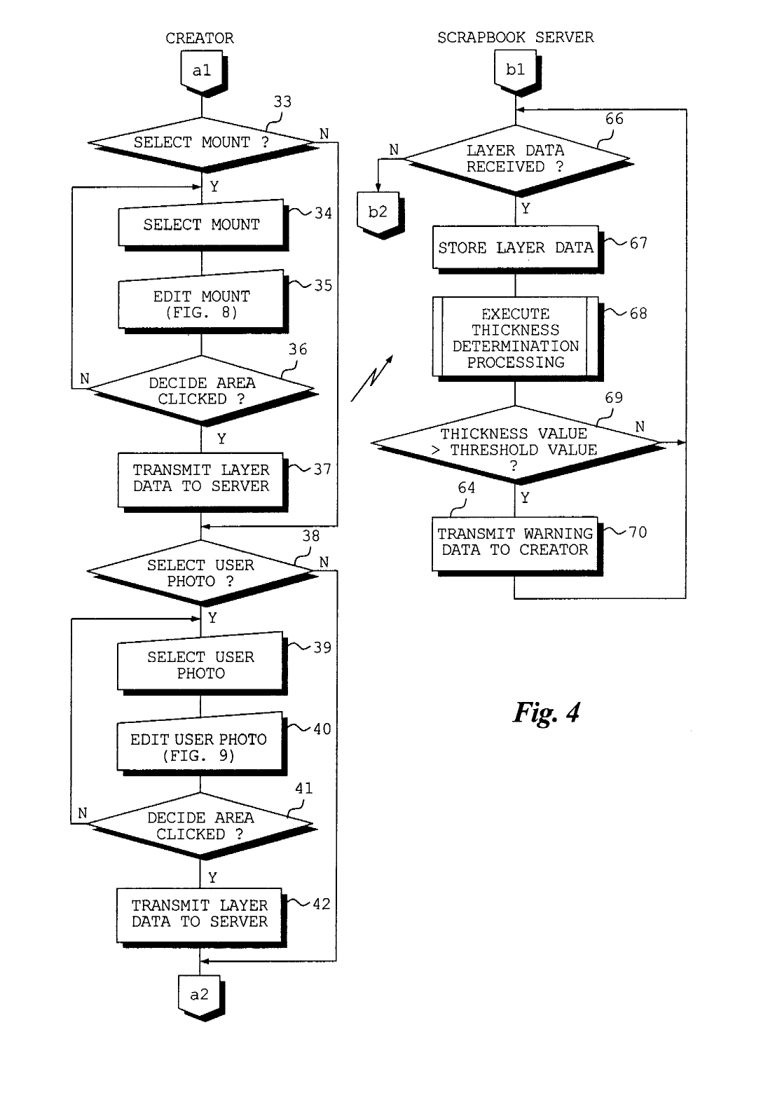

If the mount area 91 is clicked by the creator 2 with the window 80 of FIG. 7 being displayed on the display screen (step 33 in FIG. 4), paper mount images are displayed in the small window 95. A desired mount image is selected from the displayed mount images (step 34 in FIG. 4). As illustrated in FIG. 8, a selected mount image 132 is displayed in the scrapbook edit image display area 130 as the scrapbook edit image 131. Next, the selected mount image is subjected to editing such as color change and enlargement/reduction (step 35 in FIG. 4). If the selected mount image is acceptable, the decide area 109 is clicked (“YES” at step 36 in FIG. 4). In response, layer data indicating editing information, etc., regarding the selected mount image is transmitted from the computer 1 of creator 2 to the scrapbook server 5 (step 37 in FIG. 4).

Next, if the user photo area 92 is clicked (step 38 in FIG. 4), images of user photos are displayed in the small window 95. It goes without saying that image data representing the images of the user photos has been stored in the scrapbook server 5 beforehand and that the images are transmitted from the scrapbook server 5 to the computer 1 of creator 2. If a user photo image is selected from among the user photo images being displayed in the small window 95, the scrapbook edit image 131 in which a selected user photo image 133 is included is displayed in the scrapbook edit image display area 130, as illustrated in FIG. 9. The user photo image 133 is moved to a desired position by being dragged. Other part images are handled in a similar manner. The user photo image 133 is edited (step 40 in FIG. 4). If the decide area 109 is clicked (“YES” at step 41 in FIG. 4), then the layer data regarding the user photo image 133 is transmitted to the scrapbook server 5 (step 42 in FIG. 4).

Upon receiving the layer data (“YES” at step 66), the scrapbook server 5 stores the received layer data (step 67). Since images overlap in a simulation, any number of images can be superimposed regardless of the thickness of parts. When a scrapbook is actually created, however, there is a limit to overlapping because of the thickness of paper and thickness of materials such as ribbons and buttons. Accordingly, processing is executed to determine whether thickness will exceed a prescribed threshold value in a case where parts are superimposed in an actual scrapbook (step 68 in FIG. 4). If the thickness is greater than the prescribed threshold value (“YES” at step 69 in FIG. 4), then warning data is transmitted from the scrapbook server 5 to the computer 1 of creator 2 (step 70 in FIG. 4).

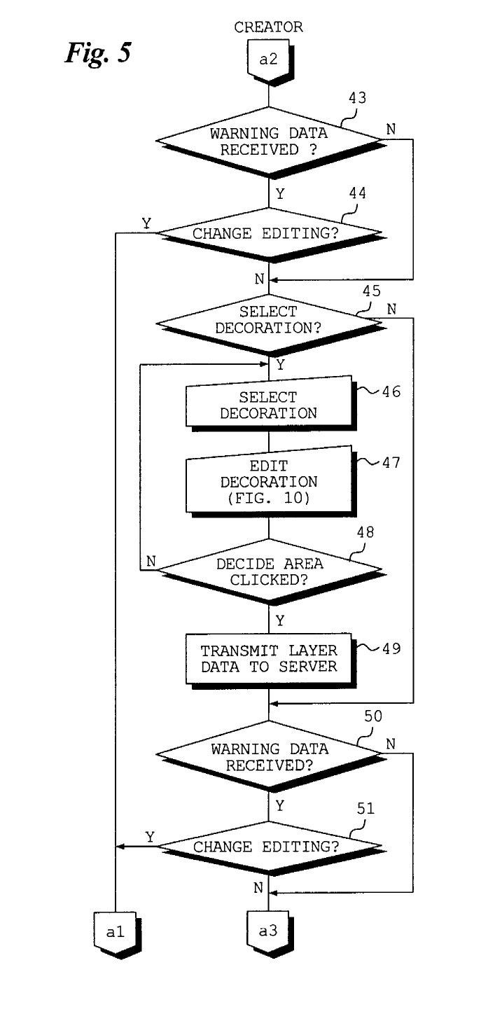

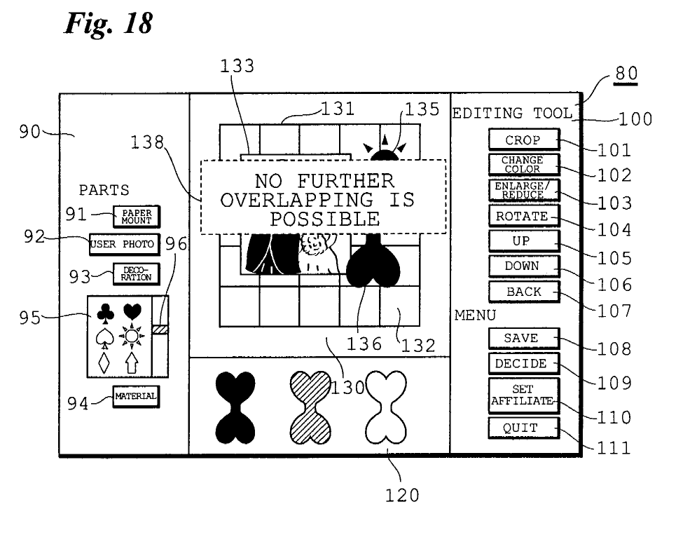

Upon receiving the warning data transmitted from the scrapbook server 5 (“YES” at step 43 in FIG. 5), a warning message is displayed in the window 80 (see FIG. 18) and an area for specifying a change in editing appears. By clicking the editing change area, editing can be performed again.

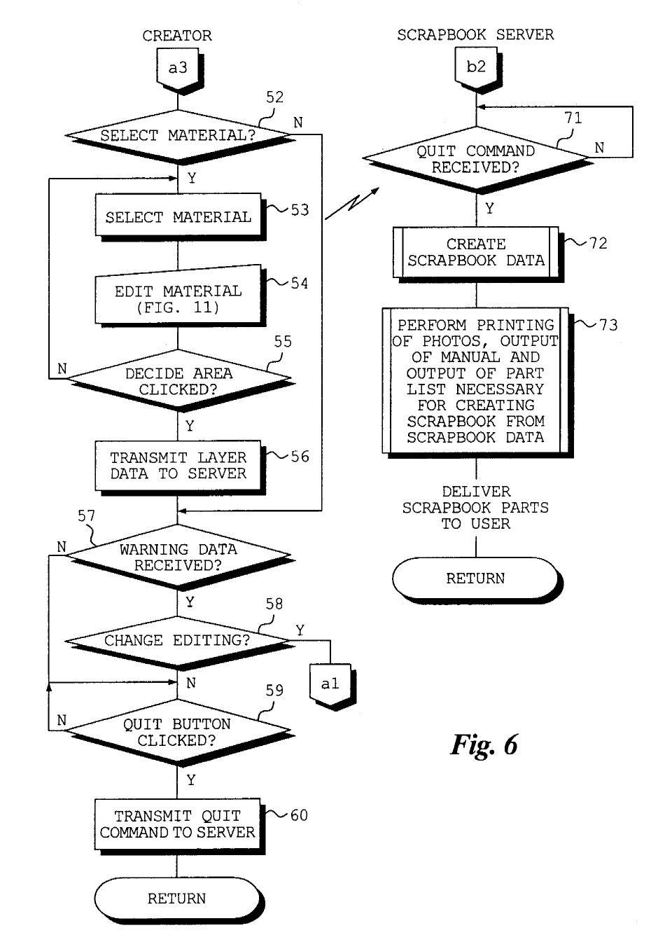

If warning data is not received (“NO” at step 43 in FIG. 5), or if editing is not changed (“NO” at step 44 in FIG. 5) even though warning data has been received, the decoration area 93 is clicked (“YES” at step 45 in FIG. 5). A decorative image is selected from within the small window 95 (step 46 in FIG. 5) and the selected decorative image is displayed on the scrapbook image, as illustrated in FIG. 10. The selected decorative image is edited (step 47 in FIG. 5). If the decide area 109 is clicked (“YES” at step 48 in FIG. 5), layer data regarding the selected decorative image is transmitted to the scrapbook server 5 (step 49 in FIG. 5). If warning data is not received by the computer 1 (“NO” at step 50 in FIG. 5), or if editing is not changed (“NO” at step 51 in FIG. 5) even though warning data has been received, the material area 94 is clicked (step 52 in FIG. 6).

Material is selected from within the small window 95 (step 53 in FIG. 6) and the selected material image is displayed on the scrapbook edit image 131, as illustrated in FIG. 11. The selected material image is edited (step 54 in FIG. 6). If the decide area 109 is clicked (step 55 in FIG. 6), then layer data is transmitted to the scrapbook server 5 (step 56). Part editing continues (step 59 in FIG. 6) unless the quit area 111 is clicked. For example, as illustrated in FIG. 12, editing is performed in such a manner that a decorative image 136 conceals decorative image 134 and partially overlaps a material image 135 and user photo image 133.

If quit area 111 is clicked (“YES” at step 59 in FIG. 6), a quit command is transmitted from the computer 1 of creator 2 to the scrapbook server 5 (step 60 in FIG. 6).

Upon receiving the quit command (step 71 in FIG. 6), the scrapbook server 5 creates scrapbook data using layer data that has been stored (step 72 in FIG. 6). Printing of photographs, output of a procedural manual and output of a parts list, etc., necessary for a scrapbook are performed using the created scrapbook data (step 73 in FIG. 6). The paper mount, photographs, decorative images and material, etc. necessary for the scrapbook are packaged and delivered to the residence of the creator 2. While looking at the procedural manual and using the parts contained in the package, the creator 2 creates the scrapbook in the manner that was simulated.

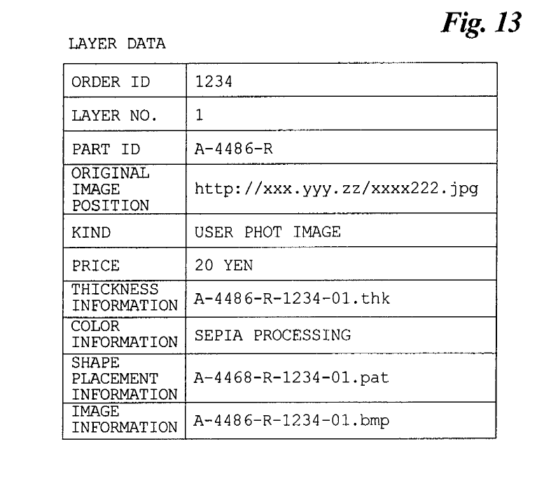

FIG. 13 illustrates an example of layer data.

The layer data is generated for every single part selected by the user in the manner described above. The layer data includes an order ID, layer number, part ID, original image position, kind, price, thickness information, color processing, shape placement information and image information. The order ID is for identifying an order and is assigned on a per-order basis. By creating layers containing part images selected in the manner described above and superimposing these layers, scrapbook edit images are generated one after another. The layer number is a number for identifying the layer. The layer number of the mount is 0. The original image position indicates the location at which the part image has been stored. The kind indicates the type of part. The price is the fee to use the part. If the image is the user image, then the price includes the printing fee. The thickness information is information indicating the actual thickness of the part. If the part has been subjected to color processing, then color processing indicates the content of this processing. The shape placement information is information indicating the placement position of the part. The image information indicates the pixel level serving as the image of the part.

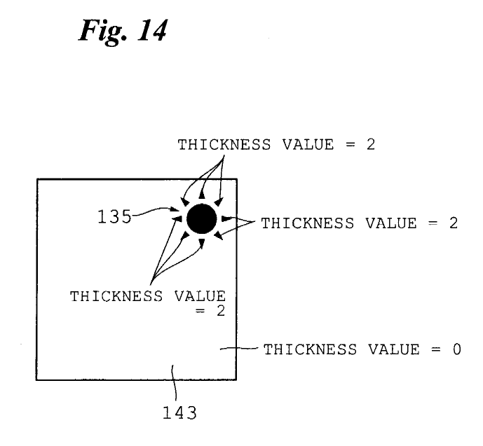

FIG. 14 illustrates thickness values indicated by the thickness information represented by the layer data.

A layer is created by selecting a part image, as described above. Assume that a layer 143 has been created by selecting part image 135. The part image 135 is an image representing the material part. The actual material utilized has a thickness of 2 mm. In layer 143, therefore, the area of part image 135 has a thickness value of 2, and the area other than that occupied by the part image 135 has a thickness value of 0. Such thickness information has been stored in the above-described layer data.

In a manner similar to the thickness information, the shape placement information indicates information regarding the position of the part image 135 (a position designated by the creator 2). The image information indicates information regarding the pixel level of the part image 135 (the pixel level with regard to RGB, usually represented by 256 levels of 0 to 255).

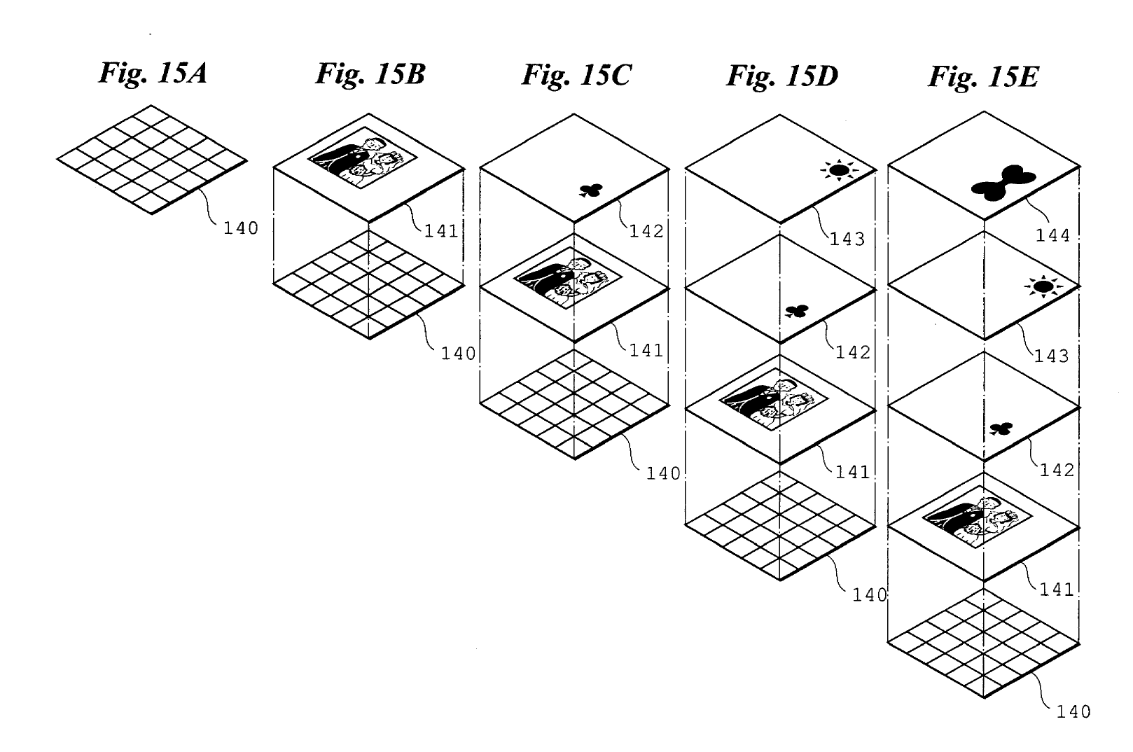

FIGS. 15A to 15E illustrate layers. The layers can be represented by layer data, as mentioned above.

With reference to FIG. 15A, a layer 140 is obtained by selecting the mount image 132. A layer 141 is obtained by selecting the user image 133, as illustrated in FIG. 15B. By superimposing the layer 141 on the layer 140, the scrapbook edit image 131 is obtained, as illustrated in FIG. 9. A layer 142 is obtained by selecting the decorative image 134, as illustrated in FIG. 15C, a layer 143 is obtained by selecting the material image 135, as illustrated in FIG. 15D, and a layer 144 is obtained by selecting the decorative image 136, as illustrated in FIG. 15E. By superimposing these layers 140 to 144, the scrapbook edit image 131 is obtained, as shown in FIG. 12. The positions of the part images in the layers are positions designated by the user.

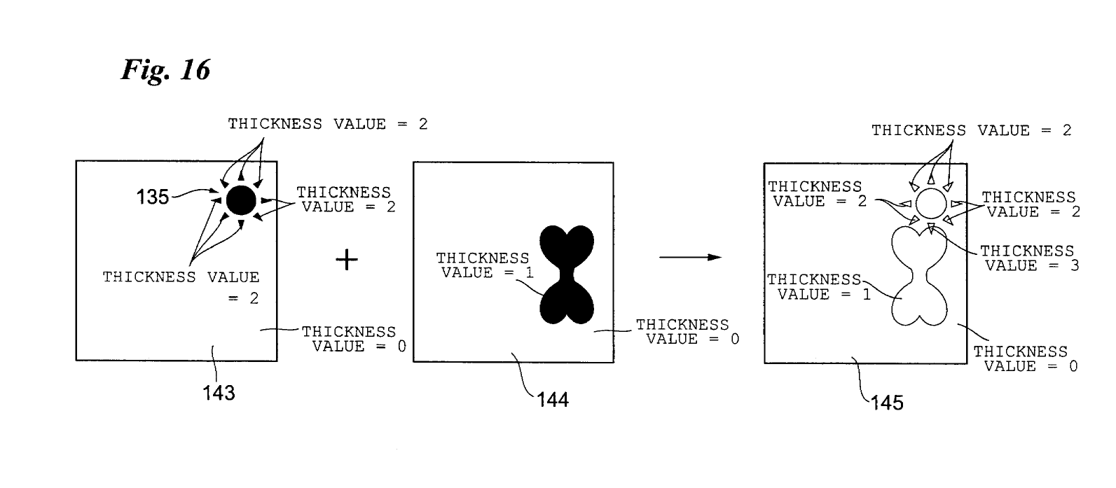

FIG. 16 illustrates thickness detection.

Assume that thickness produced by superimposing layers 143 and 144 is detected. The thickness values of layers 143 and 144 can be detected based upon the thickness information contained in the layer data. The layer 143 contains the material image 135, and the layer 144 contains the decorative image 136. The thickness value of the material image 135 contained in the layer 143 is 2, and the thickness value of the decorative image 136 contained in the layer 144 is 1. In image 145 obtained by superimposing the layers 143 and 144, the thickness value of the portion where the material image 135 and decorative image 136 overlap is 3. By raster-scanning the overlap image 145, the thickness values of the overlap image obtained by superimposing the layers 143 and 144 can be detected at every portion.

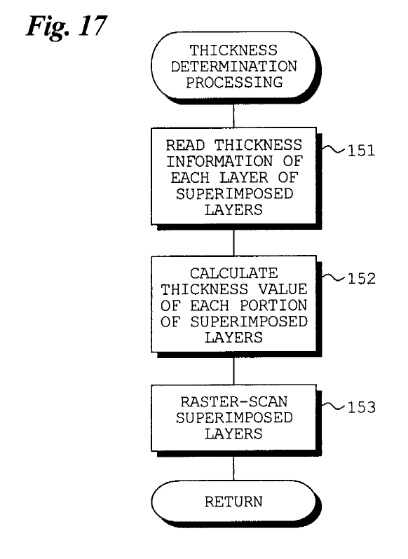

FIG. 17 is a flowchart illustrating thickness determination processing (step 68 in FIG. 4).

Thickness information of each layer superimposed as described above is read (step 151) and thickness values at each of the portions of the superimposed layers are calculated (step 152). The superimposed layers are raster-scanned (step 153) and the thickness value of each portion is detected. If the maximum value of the detected thickness values is greater than the threshold value, a warning message 138 is displayed on the computer 1 of creator 2, as illustrated in FIG. 18.

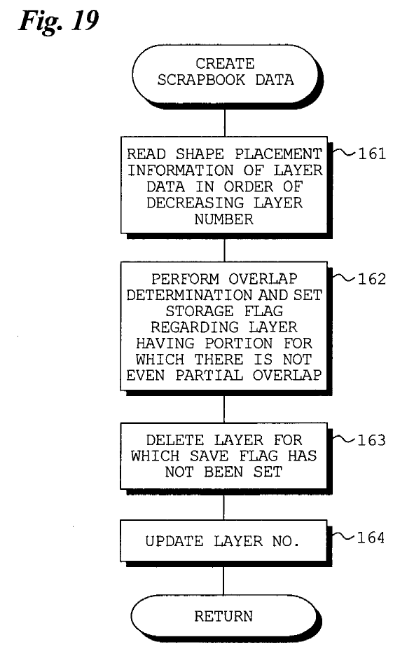

FIG. 19 is a flowchart illustrating processing for creating scrapbook data (step 72 in FIG. 6). The scrapbook data is a set of layer data. Unwanted layer data has been deleted from this set of layer data.

First, shape placement information of the layer data is read in order of decreasing layer number (step 161). On the basis of the read shape placement information, all layers are superimposed and a save flag is set with regard to a layer containing a part image having a portion for which there is not even partial overlap among all part images contained in all layers (step 162). With regard to a part image for which there is overlap with all part images, a save flag is not set as long as the layer containing this part image is not the uppermost layer. A layer for which the save flag has not been set is deleted (step 163). That is, the layer data corresponding to a layer for which a save flag has not been set is deleted. By deleting layer data, updating is performed in such a manner that the layer numbers become consecutive (step 164).

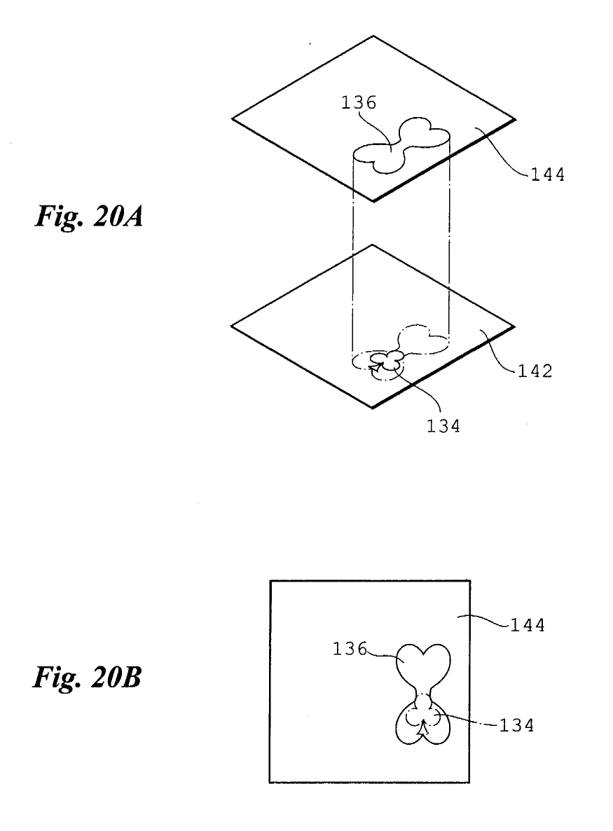

FIG. 20A illustrates the manner in which layers are superimposed, and FIG. 20B illustrates layers in superimposed form.

Assume that by superimposing the layers 144 and 143 in the manner shown in FIG. 20A, the part image 134 contained in the lower layer 142 is completely hidden by the part image 136 contained in the upper layer 144, as illustrated in FIG. 20B. In a case where the part image 134 contained in the lower layer 142 is thus completely hidden by the part image 136 contained in the upper layer 144, the save flag is not set for the lower layer 142 and is deleted, and the layer data is deleted as well. Layer data for which a part image is thus completely hidden is deleted and the set of remaining layer data becomes the scrapbook data. A procedural manual, etc., is created based upon the scrapbook data. A creation procedure for which a part will not be exposed on the surface of the scrapbook is not described in the procedural manual. Further, a part specified by layer data that has been deleted is not included in the package delivered to the creator 2. Thus, an unwanted part can be prevented from being delivered to the creator of the scrapbook.

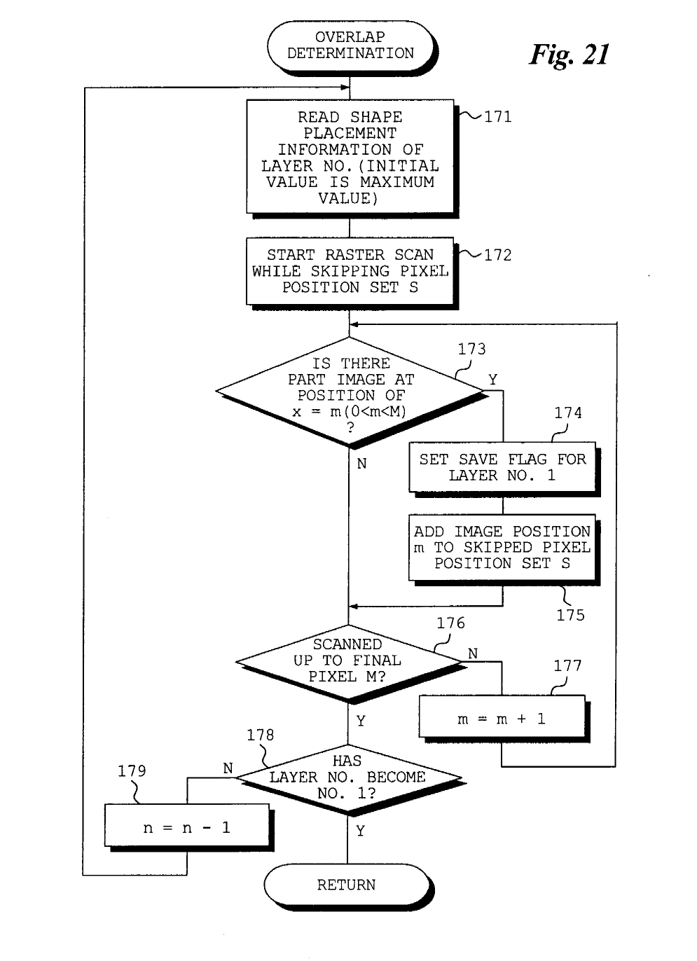

FIG. 21 is a flowchart illustrating overlap determination processing (step 162 in FIG. 19).

Shape placement information of layer number n (the initial value is the maximum value and corresponds to the selected number of part images with the exception of the mount) is read (step 71). As will be described later, raster scanning is started while skipping a pixel position set S in which a part image exists in the upper layer (step 172).

It is determined whether a part image exists at a position x=m (0<m<M, where M is the maximum value of a pixel in the layer) in the layer (step 173). If a part image exists, this means the inclusion of a part image that does not overlap a part image contained in the layer above the layer in which the first-mentioned part image exists. Accordingly, a save flag is set for this layer number (step 174). The position m at which the part image has been detected is added to the skipped set S of pixel positions (step 175). If a part image does not exist at the position x=m (“NO” at step 173), the processing of steps 174 and 175 is skipped.

The position m is incremented in such a manner that raster scanning is performed up to the final position M in this layer (“YES” at step 176; step 177). Overlap determination is repeated with regard to the lower layer until the layer number becomes 1 (steps 178, 179).

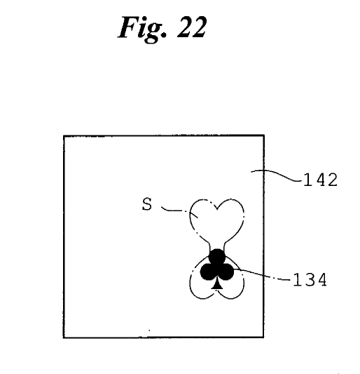

FIG. 22 illustrates the manner in which a layer is superimposed.

The part image 136 is a part image in the upper layer, and the part image 134 is a part image in the lower layer. The position at which the part image 136 contained in the upper layer exists is added to the skipped pixel position set S, as described above. In a case where the upper layer and the lower layer have been superimposed, the part image 134 in the lower layer comes to be included in the skipped pixel position set S and a part image will not exist at a position that lies outside the skipped pixel position set S. As described above, therefore, a save flag is not set for the layer 142 containing the part image 134 and becomes the target for deletion.

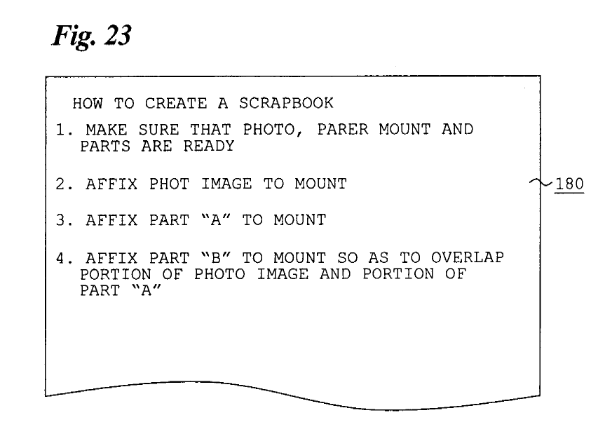

FIG. 23 illustrates an example of a procedural manual.

As mentioned above, a procedural manual 180 is bundled together with a mount and parts in the package delivered to the creator of the scrapbook. While viewing the procedural manual 180, the creator creates the scrapbook in the manner that was simulated.

The procedural manual 180 is created based upon scrapbook data. The scrapbook data is composed of a plurality of items of layer data, as mentioned above; layer data which will affix a part that will not appear on the surface of the scrapbook has been deleted. Accordingly, an operation affixing a part that will not appear on the surface of the scrapbook is not described in the procedural manual 180 even if it is an operation that was performed by the creator in the simulation. By creating the scrapbook while observing the procedural manual 180, the affixing of parts needlessly can be prevented. For example, as illustrated in FIG. 10, the decorative part 134 has been affixed to the mount image 132 in the simulation. However, since the decorative image 134 is completely hidden by the decorative image 136, as illustrated in FIG. 12, the procedural step of affixing the decorative image 134 is not set forth in the procedural manual 180.

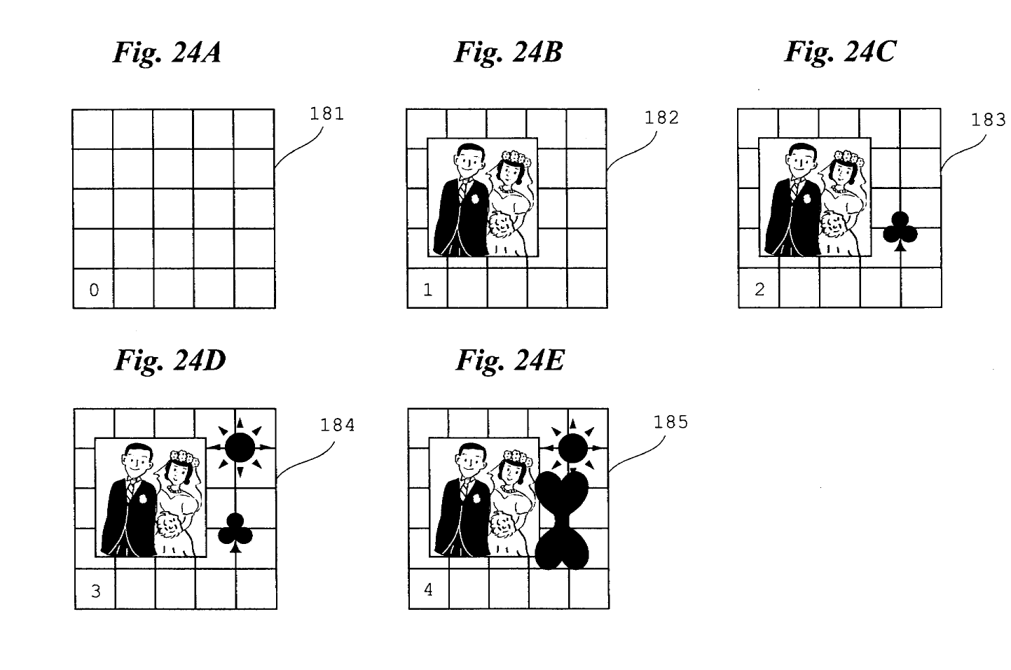

FIGS. 24A to 24E illustrate another example of a procedural manual.

This procedural manual is referred to as a “pictorial procedural manual”. This manual is similar to what would be obtained by printing, sheet by sheet whenever a part is affixed, scrapbook images generated successively in the simulation performed by the creator 2 in the manner illustrated in FIGS. 7 to 12. Naturally, the scrapbook images may actually be printed sheet by sheet whenever a part is affixed and the printed images themselves may be adopted as the pictorial procedural manual.

The pictorial procedural manual can also be created using scrapbook data. As mentioned above, scrapbook data is a set of a plurality of items of layer data, and a single sheet of a pictorial procedural manual is created by each item of layer data among the plurality of items thereof.

The layer number included in the layer data is written at the lower left of each of sheets 181 to 185 of the pictorial procedural manual illustrated in FIGS. 24A to 24E, respectively. The layers corresponding to the sheets of the pictorial procedural manual are assumed to be color part images. However, it is assumed that the part image in the underlying layer is monochrome (it may be represented solely by an outline). For example, in sheet 183 of the pictorial procedural manual shown in FIG. 24C, the part image 134 is a color image, but the user image 133 is monochrome. In sheet 184 of the pictorial procedural manual shown in FIG. 24D, the part image 135 is a color image and the part image 134 and user image 133 are monochrome images. In sheet 185 of the pictorial procedural manual shown in FIG. 24E, the part image 136 is a color image, but the part images 133 to 135 are monochrome. Since the part image of an underlying layer is not a color image but is represented by a monochrome image, which part corresponding to a part image should be affixed above can be determined at a glance. The sequence through which the scrapbook is created can also be determined from the layer number.

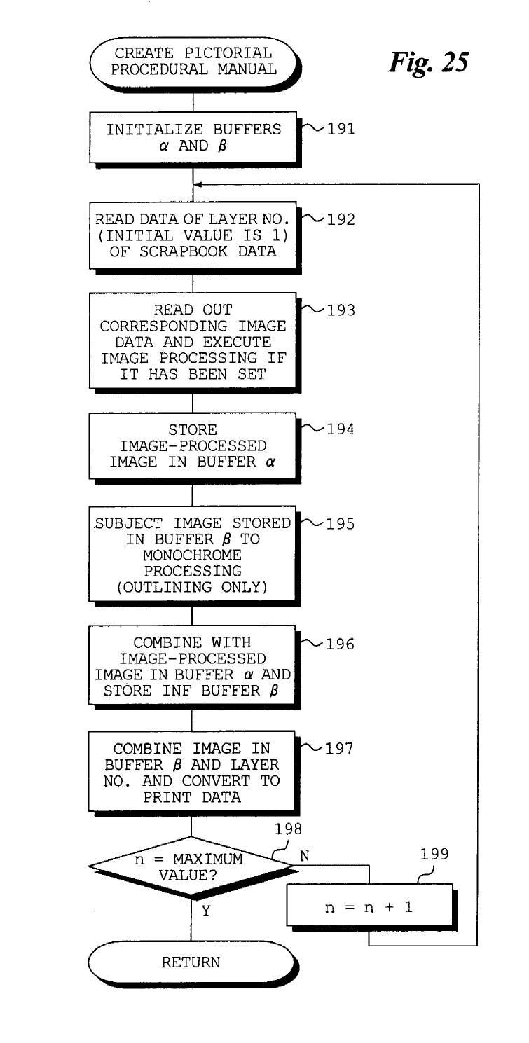

FIG. 25 is a flowchart illustrating processing for creating a pictorial procedural manual.

The above-described pictorial procedural manual is such that the part image contained in the upper layer of a superimposed layer is in color, while a part image contained in the underlying layer is monochrome (or an outline only). For this reason, there are defined a buffer a (a prescribed first memory area of memory 13) for temporarily storing image data representing a color part image contained in an upper layer, and a buffer β (a prescribed second memory area of memory 13) for temporarily storing image data representing a monochrome part image. The buffers α and β are initialized (step 191).

Layer data of layer number n (the initial value of n is 1) is read from among the layer data constituting the scrapbook data (step 192). Image data representing a part image contained in a layer specified by the read layer data is read, and image processing is executed in a case where image processing such as color processing has been set for this part image (step 193). The image data that has undergone image processing is stored in buffer α (step 194). The layer of layer number 1 is the layer 141 overlying layer 140 of the mount, as illustrated in FIG. 15B. If color processing has been set for the part image 133 contained in layer 140, then image processing is applied to the image data representing the part image 133 and the processing data is stored in buffer α.

The image data that has been stored in buffer β is subjected to monochrome processing (or outlining processing for producing only an outline) (step 195). The monochrome part image represented by the image data that has been stored in buffer β is combined with the layer containing the image-processed color part image represented by the image data that has been stored in buffer α and the result is stored in buffer β (step 196). The layer number is combined with the layer that has been stored in buffer β and the result is converted to print data (step 197). One sheet of the pictorial procedural manual is obtained by this print data. If the part image contained in the layer of layer number 1 has been subjected to image processing, image data will not have been stored in buffer β. As illustrated in FIG. 24B, therefore, a sheet of the pictorial procedural manual on which a part image has been affixed to the mount image is obtained.

The processing of steps 192 to 197 is repeated while incrementing the layer number until layer number n takes on the maximum value (“NO” at step 198). If the above-mentioned processing is executed, a superimposed layer corresponding to the sheet 182 of the pictorial procedural manual illustrated in FIG. 24B will have been stored in buffer β. The part image 133 contained in this layer is made monochrome (the mount image 132 also is made monochrome if necessary) and this is combined with the color part image 134 contained in the upper layer, whereby the sheet 183 of the pictorial procedural manual shown in FIG. 24C is obtained. Similarly, the sheets 181 to 185 of the pictorial procedural manual, in which the part image 135 is in color and the other part images 133 and 134 are monochrome, as illustrated in FIG. 24D, and in which the part image 136 is in color and the other part images 133 and 135 are monochrome, as illustrated in FIG. 24E, are obtained.

In the pictorial procedural manual described above, the part image contained in the uppermost layer is assumed to be a color image and the part images contained in the underlying layers are assumed to be monochrome. However, the results of printing the scrapbook edit image illustrated in FIGS. 8 to 12 may just as well be adopted as the pictorial procedural manual.

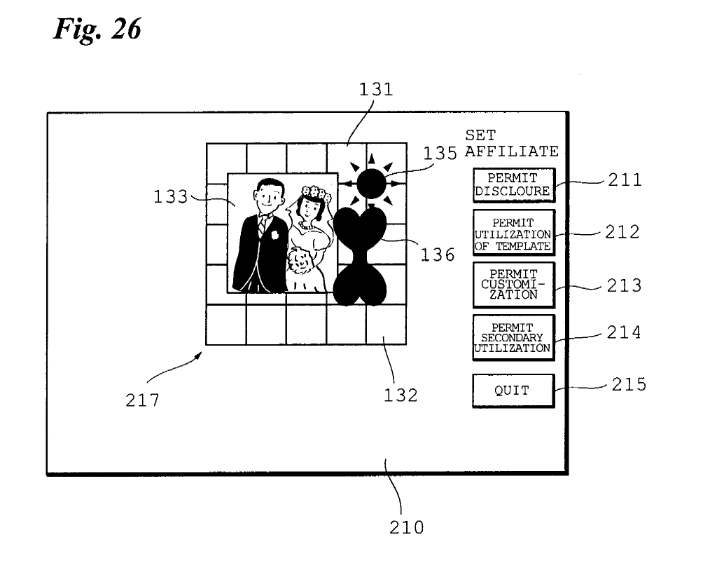

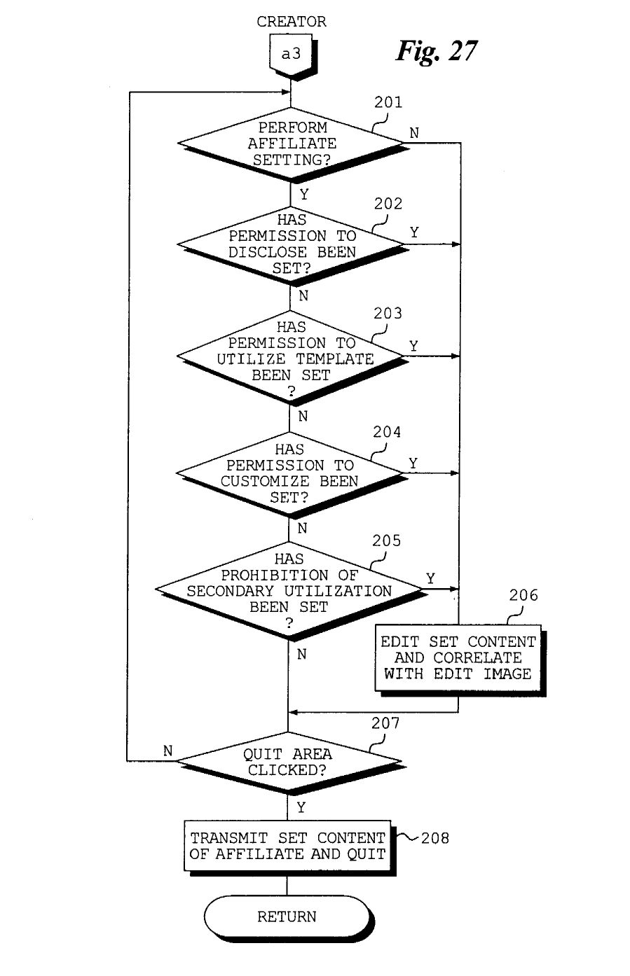

FIGS. 26 and 27 concern the setting of an affiliate, in which FIG. 26 illustrates a window displayed on the display screen of the computer 1 of creator 2, and FIG. 27 is a flowchart illustrating processing for setting an affiliate.

The above-described scrapbook is created by the creator and scrapbook images obtained by imaging the created scrapbook are uploaded to a website, thereby enabling the scrapbook to be utilized by an affiliate. The setting of mode of utilization by the affiliate is referred to as an “affiliate setting”. Naturally, it may be so arranged that the mode in which an affiliate is utilized is set utilizing the scrapbook edit image finally obtained by a simulation in the manner described above without utilizing a scrapbook edit image obtained by imaging a created scrapbook.

By clicking the affiliate setting area 110 included in the window 80 illustrated in FIGS. 7 to 12, an affiliate setting window 210 shown in FIG. 26 is displayed on the display screen of the computer 1 of creator 2. The affiliate setting window 210 includes a disclosure permission area 211, a template-utilization permission area 212, a customization permission area 213, a secondary-utilization prohibition area 214 and a quit area 215.

The disclosure permission area 211 permits the viewing of a scrapbook edit image. However, this area is clicked by the creator 2 in a case where a third party is not permitted to simulate the scrapbook using the scrapbook edit image.

The template-utilization permission area 212 is clicked by the creator 2 in a case where simulation of the scrapbook is permitted using a scrapbook edit image from which the photographic image of the creator 2 has been excluded. If template utilization has been permitted, the photographic image of the creator 2 is removed from the scrapbook edit image and the photographic image of the user can be affixed instead.

The customization permission area 213 is clicked by the creator 2 in a case where the scrapbook edit image of the creator 2 is permitted to be customized.

In a case where a scrapbook edit image created by a user who has utilized a scrapbook edit image of the creator 2 contains a decorative image created by the creator 2, the secondary-utilization prohibition area 214 is clicked by the creator 2 if this decorative image is not permitted to be utilized by yet another party. In a case where a scrapbook edit image of the creator 2 contains a decorative image created by the creator 2, a user who has utilized the scrapbook edit image of the creator 2 is capable of setting only disclosure permission in an affiliate setting made by the user.

With reference to FIG. 27, the affiliate setting area 110 is clicked by the creator 2 if the affiliate setting is made (“YES” at step 201). In response, the affiliate setting window appears on the display screen of the computer 1 of creator 2. If the disclosure permission area 211 is clicked (“YES” at step 202), then disclosure permission is set. If the template-utilization permission area 212 is clicked (“YES” at step 203), then template permission is set. If the customization permission area 213 is clicked (“YES” at step 204), then customization permission is set. If the secondary-utilization prohibition area 214 is clicked (“YES” at step 205), then prohibition of secondary utilization is set. Data indicating the set content is correlated with the scrapbook edit image (step 206). For example, data or a flag indicating the set content is added to the above-described layer data.

If the quit area 215 is clicked (“YES” at step 207), a command to quit the setting of an affiliate is transmitted from the computer 1 of creator 2 to the scrapbook server 5 (step 208).

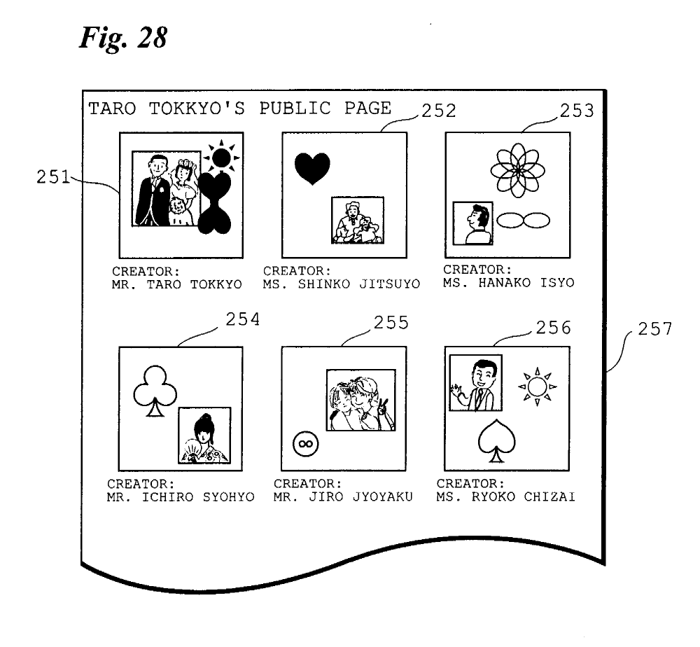

In FIGS. 28 to 30, a user other than the creator 2 performs a simulation for scrapbook creation (creates a scrapbook edit image) using a scrapbook image created by the creator 2, in the manner described above. It goes without saying that the above-mentioned scrapbook data has been stored in the scrapbook server 5 on a per-creator basis.

FIG. 28 illustrates an example of an image (a public page 257) at a site where a scrapbook edit image (scrapbook image) created by Taro Tokkyo, who is creator 2, is being displayed.

The public page 257 includes not only a thumbnail image 251 of a scrapbook edit image created by Taro Tokkyo, who is creator 2, but also thumbnail images 252, 253, 254, 256, etc., of scrapbook edit images created by other creators.

The thumbnail images 251, etc., are clickable. By clicking one of the thumbnail images 251, etc., request data is transmitted to the site containing the scrapbook edit image that corresponds to the clicked thumbnail image. When the request data is received by the scrapbook server, a window containing the scrapbook edit image corresponding to the clicked thumbnail image 251, etc., is displayed on the display screen of the computer of the user. For example, if the thumbnail image 251 is clicked by the user, the user window 80 shown in FIG. 12 is displayed on the display screen of the user computer.

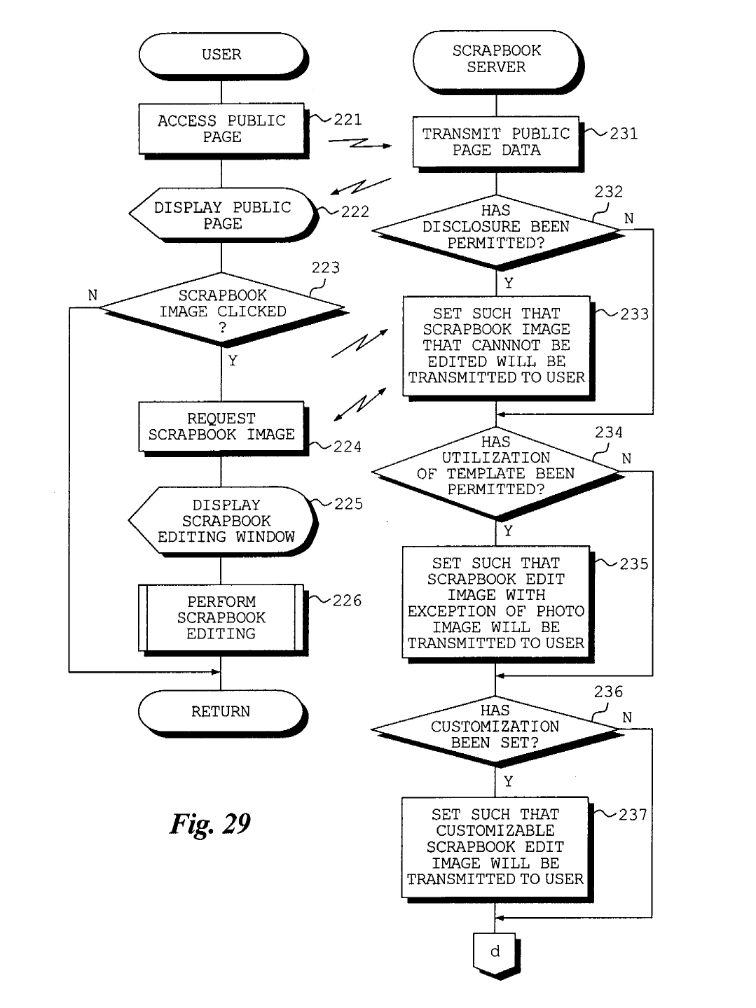

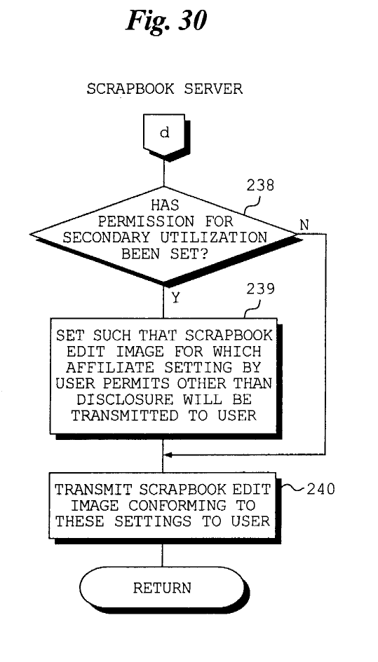

FIGS. 29 and 30 are flowcharts illustrating processing executed between the user computer and the scrapbook server.

A command to access a public page is transmitted to the scrapbook server 5 by the user computer (step 221). When the access command is received by the scrapbook server 5, the public page data is transmitted from the scrapbook server 5 to the user computer (step 231).

When the public page data is received by the user computer, the public page is displayed on the display screen of the user computer, as illustrated in FIG. 28 (step 222). If a thumbnail image of a scrapbook edit image contained on the public page is clicked (“YES” at step 223), request data for requesting the corresponding scrapbook edit image is transmitted from the user computer to the scrapbook server (step 224).

When the request data transmitted from the user computer is received by the scrapbook server 5, the affiliate setting of the scrapbook edit image corresponding to the request is checked. If disclosure has been permitted (“YES” at step 232), the image data representing the scrapbook image whose viewing only is permitted but whose editing is not is set so as to be transmitted to the user (step 233). If permission to utilize the template has been set (“YES” at step 234), image data representing the scrapbook edit image with the exception of the photographic image is set so as to be transmitted to the user (step 235). If permission for customization has been set (“YES” at step 236), then image data representing a scrapbook edit image for which movement or deletion, etc., of a part image constituting the scrapbook edit image is permitted is set so as to be transmitted to the user to enable customization (step 237). If prohibition of secondary utilization has been set (“NO” at step 238), then edit image data representing a scrapbook edit image for which the affiliate setting by the user does not permit anything but disclosure is set so as to be transmitted to the user (step 239).

Image data representing a scrapbook edit image (a scrapbook image for editing) conforming to the above-mentioned settings is transmitted from the scrapbook server 5 to the user computer (step 240).

When the image data representing scrapbook edit image is received by the user computer, the scrapbook edit image is displayed on the display screen of the computer, as illustrated in FIG. 12 (step 225). A scrapbook simulation such as editing of a scrapbook image can be performed utilizing the scrapbook edit image created by a creator who is another individual, and an order for creating a scrapbook in the manner described above can be issued (step 226).

If the user performs a simulation and issues an order for creating a scrapbook (i.e., if the quit command is transmitted), utilization-mode data indicating how the scrapbook edit image is to be utilized also is transmitted to the scrapbook server 5. The utilization-mode data is created based upon the editing history of the scrapbook edit image. The editing history is updated by clicking the decide area 109 whenever the scrapbook edit image is edited. Data representing the editing history is transmitted from the user client computer to the scrapbook server 5 as utilization-mode data. Since the user editing history is ascertained at the scrapbook server 5, the latter makes a comparison with the scrapbook edit image represented by the scrapbook edit image data of the creator that was transmitted from the scrapbook server 5, whereby the scrapbook server 5 can detect how the user utilized the scrapbook edit image of the other person. By comparing the scrapbook edit image finally decided by the user and the scrapbook edit image of the creator represented by the scrapbook edit image data that was transmitted from the scrapbook server 5 to the user client computer, whether the user utilized the scrapbook edit image of the creator can also be detected. In this case, identification data, which indicates which part image, etc., has been designated and which is transmitted from the user client computer to the scrapbook server 5 whenever the decide area 109 is clicked serves as the utilization-mode data.

In a case where a scrapbook edit image created by a creator who is another individual (it goes without saying that the creator and the user may be the same and may perform the above-described editing utilizing his/her own created scrapbook edit image) has been utilized and edited, the above-described procedural manual also is in accordance with the content of editing. For example, if, in a case where the scrapbook edit image 131 shown in FIG. 12 has been utilized, only the photographic image 133 has been changed to another photographic image, the procedural manual that is created indicates the procedure for creating a scrapbook in which only the photographic image has been changed to a new one. Further, a pictorial procedural manual in which the photographic image 133 has been changed in the illustration of FIGS. 24A to 24E is created. Even in the case where a simulation for creating a scrapbook has been performed utilizing a scrapbook edit image created by another individual, a procedural manual that contains a procedure for creating the scrapbook created by this other individual is created and is delivered to the user. Also in a case where a scrapbook creation simulation has been performed utilizing a scrapbook edit image created by another individual with a different mode of utilization, it will be understood that a procedural manual that enables the user to create the scrapbook is similarly created and delivered to the user.

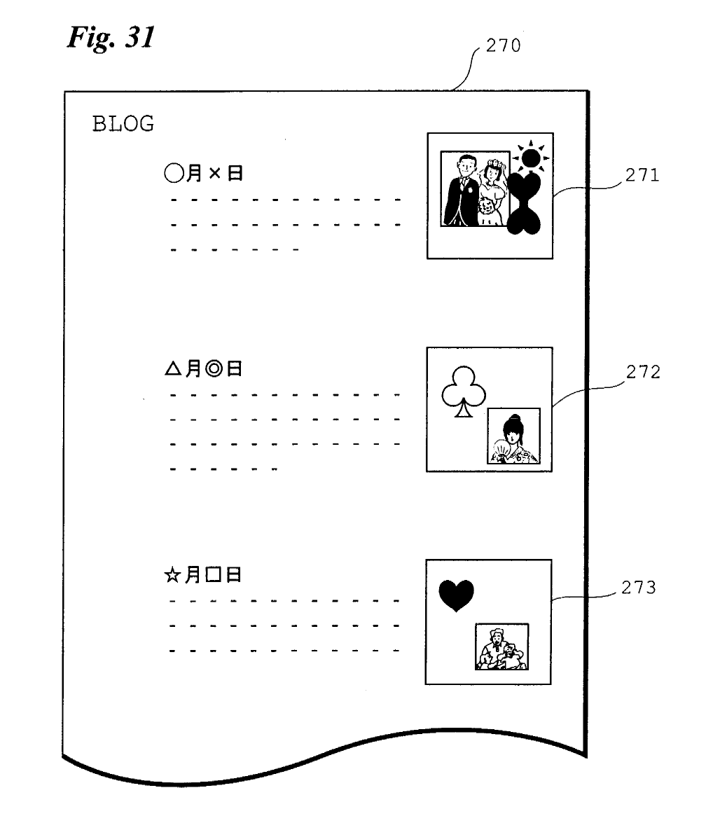

FIGS. 31 and 32 illustrate another embodiment in which a scrapbook is simulated utilizing a scrapbook edit image created by the creator 2. FIG. 31 illustrates the window of a blog displayed on the display screen of the user computer.

A blog window 270 includes not only a thumbnail image 271 of a scrapbook edit image created by Taro Tokkyo, who is the creator 2, but also thumbnail images 272, 273, 274, etc., of scrapbook edit images created by other creators. These thumbnail images 272, etc., are the same as the thumbnail images 251, etc., contained on the public page described above and are clickable. Data for displaying the blog window 270 may be transmitted to the client computer from a server that is different from the scrapbook server 5.

FIG. 32 corresponds to FIG. 29 and is a flowchart illustrating processing executed between the user computer and the scrapbook server. Processing steps in FIG. 32 identical with those shown in FIG. 29 are designated by like step numbers and need not be described again.

When request data is transmitted to the scrapbook server in order to access the blog (step 261), blog data for displaying the blog is transmitted from the scrapbook server 5 to the user computer (step 263).

In response, the blog window 270 shown in FIG. 31 is displayed on the display screen of the user computer (step 262). Processing executed in accordance with clicking of the scrapbook edit image is then executed and is similar to that described above.

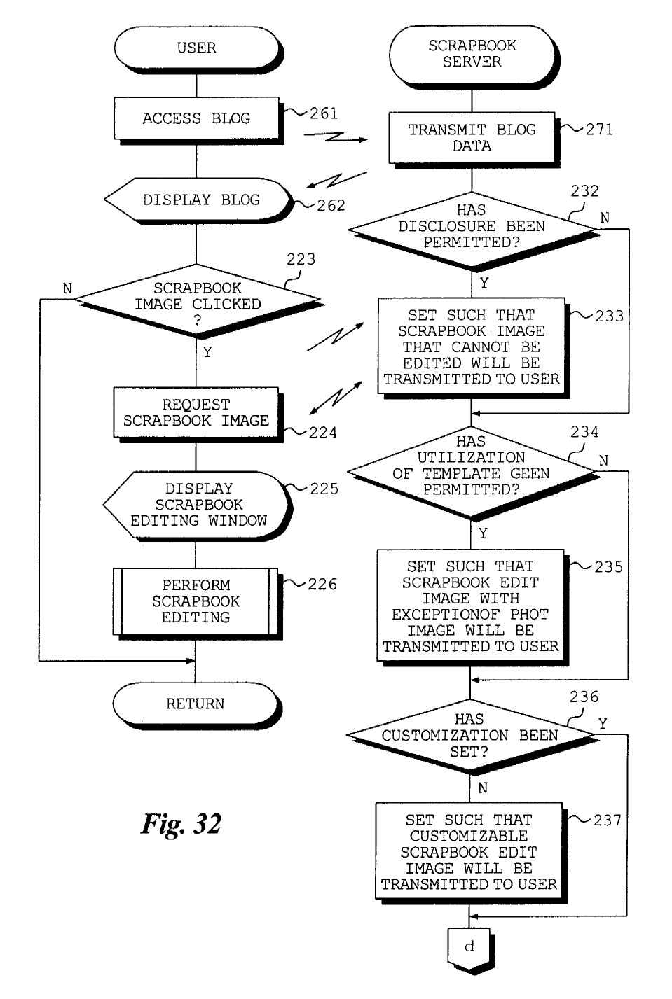

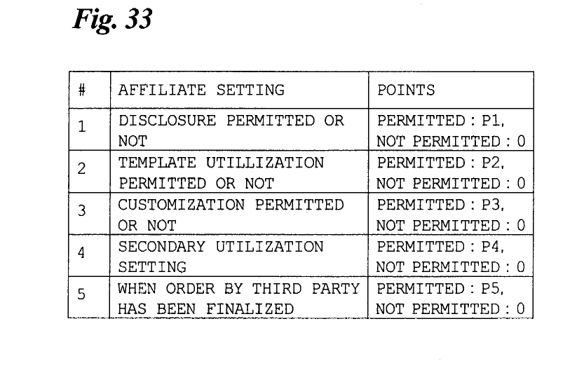

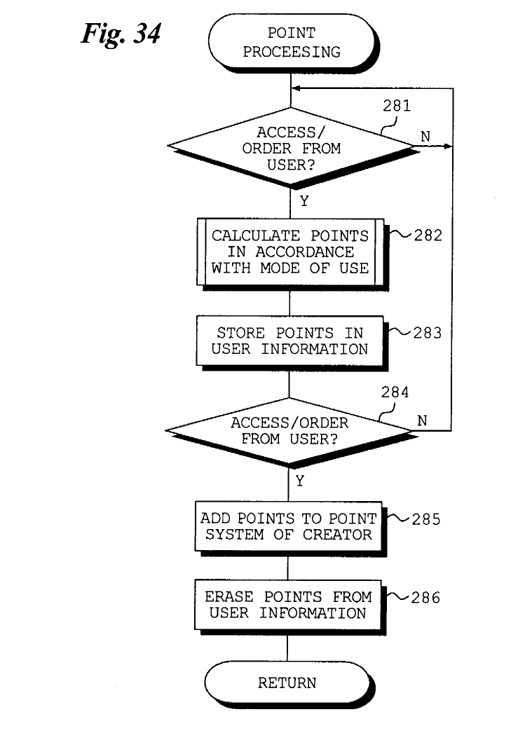

FIGS. 33 and 34 concern processing for providing a creator with points that differ depending upon the mode in which the user has utilized a scrapbook edit image created by the creator 2.

FIG. 33 illustrates the corresponding relationship between set affiliate content and points conforming to the set content.

As described above, an affiliate setting includes whether or not disclosure is permitted, whether or not template utilization is permitted, whether or not customization is permitted, and whether or not secondary utilization is permitted. Points are decided in accordance with whether permission is granted or not. In addition to these, however, in a case where a user order has been finalized, points are also given to the creator of the scrapbook edit image created in connection with finalization of the order.

In a case where use has been made of a scrapbook edit image for which permission to disclose has been set, point P1 is given to the creator. In a case where use has been made of a scrapbook edit image for which permission to utilize a template has been set, point P2 is given to the creator. In a case where use has been made of a scrapbook edit image for which permission to customize has been set, point P3 is given to the creator. In a case where use has been made of a scrapbook edit image for which permission for secondary utilization has been set, point P4 is given to the creator. In a case where a user order has been finalized, point P5 is given to the creator. In a case where none of these has been set, no points are given to the creator. The size relationship among points P1 to P4 is set and changed freely by the scrapbook server 5.

FIG. 34 is a flowchart illustrating point processing.

As described above, it is determined whether a scrapbook edit image created by the creator 2 has been accessed or whether a scrapbook has been ordered utilizing this scrapbook edit image (step 281). In case of access or an order (“YES” at step 282), utilization-mode data is transmitted from the creator 2 to the scrapbook server 5, as described earlier, and a point is calculated in accordance with the mode of utilization, as illustrated in FIG. 33 (step 283). The calculated point is stored in the user information of the creator of the scrapbook edit image that has been utilized (step 283). If a point-back day arrives (“YES” at step 284), a point is added to the point system of the creator (step 285). By adding the point to the point system of the creator, the point is erased from the user information of the creator (step 286). Thus the point conforming to the mode of utilization is given to the creator of the scrapbook edit image utilized.

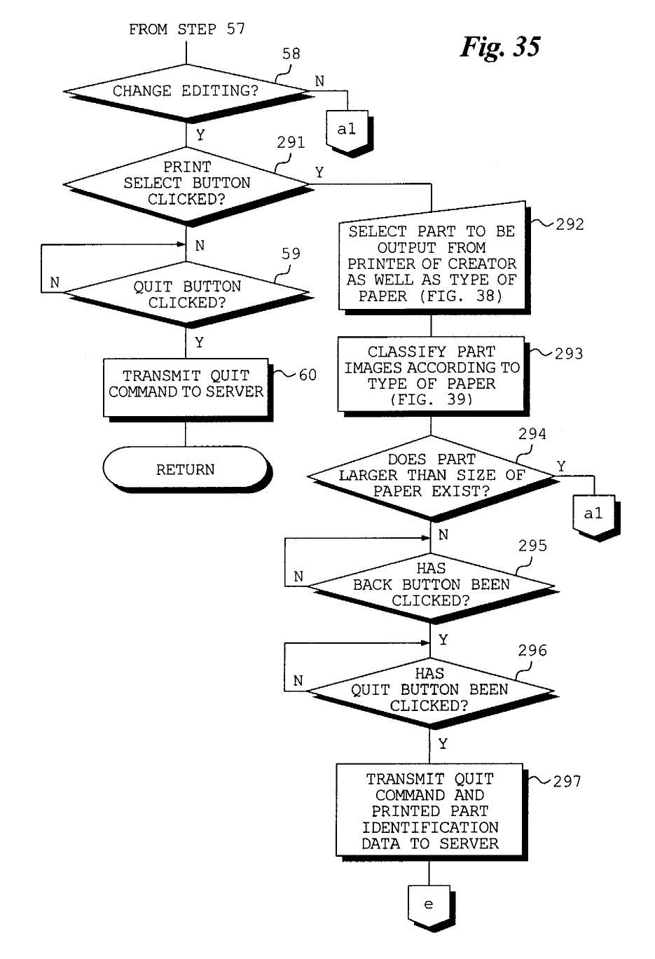

FIGS. 35 to 46 illustrate a modification.

In this modification, the creator 2 (or user) prints a paper mount, user photograph or decorative image, etc., using a printer at home. In a case where printing is performed using a printer at home, placement of decorative images is decided in such a manner that as many of the decorative images as possible will be printed on one sheet of paper in order to conserve paper and ink (toner).

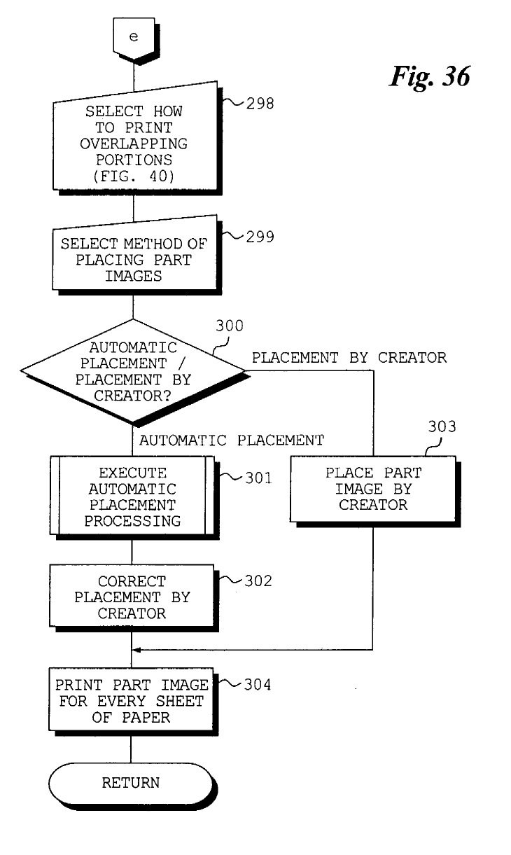

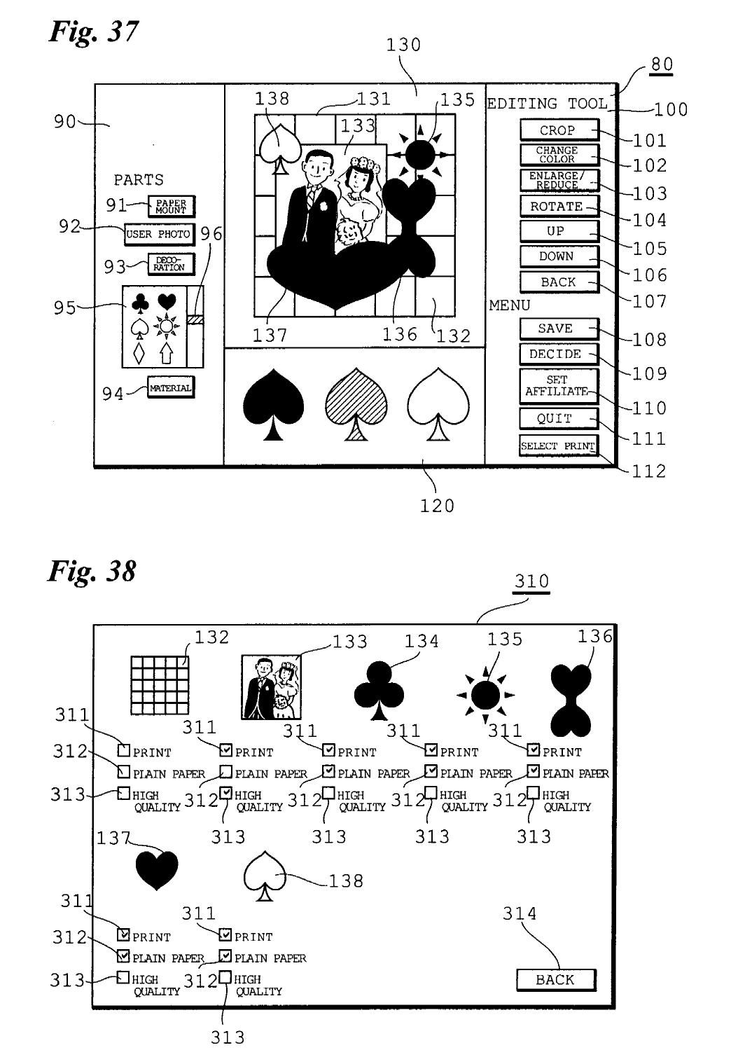

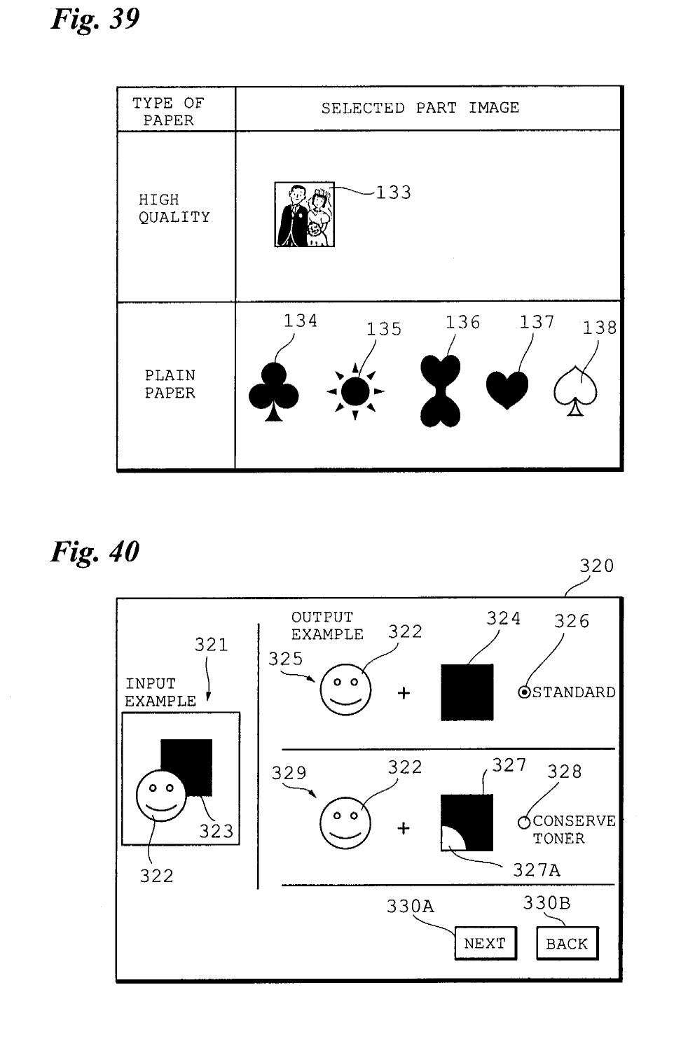

FIGS. 35 and 36 are flowcharts illustrating processing executed by the computer 1 of the creator 2. FIGS. 37, 38 and 40 are examples of windows displayed on the display screen of the display unit of computer 1. FIG. 39 illustrates the relationship between an image selected as a part image to be printed by the printer of creator 2 and the type of paper used in this printing.

As shown in FIG. 37, a print select button 112 is formed at the lower-right portion of the window 80 displayed on the display unit of the creator. The print select button 112 is clicked by the creator in a case where a decorative image or the like to be printed by the printer of the creator is selected. In comparison with the edit image (see FIG. 12) simulated in the manner described above, decorative images 137 and 138 have been added on in FIG. 37.

With reference to FIG. 35, if the print select button 112 is clicked (“YES” at step 291), a print select window 310 shown in FIG. 38 appears on the display screen of the display unit of creator 2. The print select window 310 that appears is used to select the part to be printed using the computer of the creator as well as the type of paper (step 292).

FIG. 38 illustrates an example of the print select window 310. The mount image 132, user photo image 133, decorative images 134, 136 to 138 and material image 135 selected by the creator 2 in the manner described are being displayed in the print select window 310. Displayed below these images 132 to 138 are characters reading “PRINT” and print check boxes 311 situated on the left side of the “PRINT” characters. Displayed below the “PRINT” characters and print check boxes 311 are characters reading “PLAIN PAPER” and plain paper check boxes 312 situated on the left side of the “PLAIN PAPER” characters, as well as characters reading “HIGH QUALITY” and high-quality paper check boxes 313 situated on the left side of the “HIGH QUALITY” characters. With regard to images among the images 132 to 138 to be printed by the printer of the creator 2, the print check boxes 311 are underlying the images 132 to 138 are clicked by the creator 2. When this is done, a check mark appears in the print check box 311 clicked. The plain paper check box 312 is clicked by the creator 2 if printing is to be performed on plain paper, and the high-quality paper check box 313 is clicked by the creator 2 if printing is to be performed on high-quality paper. When this is done, a check mark appears in the check box clicked. Furthermore, a button 314 on which “BACK” characters are displayed is being displayed at the lower right of the print select window 310. By clicking the button 314, the editing window 80 shown in FIG. 37 is displayed on the display screen of the display unit of the creator 2.

Part images are classified for every paper type when part images to be printed by the printer of the creator 2 and types of paper to be printed on are selected (step 293).

FIG. 39 illustrates an example of part images classified according to type of paper. In this example, it is assumed that user photo image 133, decorative images 134 and 136 to 138 and material image 135 have been selected as images to be printed by the printer of the creator 2. The mount image 132 has not been selected. As mentioned above, the decorative image 134 is concealed below the decorative image 136. It goes without saying, therefore, that this image need not be printed. Further, although the material corresponding to the material image 135 is not printed on paper, it may be so arranged that the material image is printed using the printer of the creator 2 in the manner of this modification. In this modification, it is assumed that the user photo image 133 has been selected for printing on high-quality paper and that the decorative images 134 and 136 to 138 and material image 135 have been selected for printing on plain paper.

With reference again to FIG. 35, it is determined whether there is a part that is larger than the size of the paper to be printed on (step 294). If a part larger than the size of the paper exists, then editing processing is executed again so as to make the size of the part smaller than the size of the paper (processing from step 33 of FIG. 4 is executed). It goes without saying that paper size is input beforehand by the creator 2. Further, among the parts, the size of the paper mount is selected beforehand by the creator 2, and images of parts that are large relative to the size of the paper mount selected are displayed on the edit image in the editing processing described above.

If a part larger than the size of the paper does not exist (“NO” at step 294), the editing window 80 shown in FIG. 37 is displayed by clicking the BACK button 314 (“YES” at step 295). A quit command is transmitted to the scrapbook server 5 (step 297) as described above by clicking the quit button 111 in the editing window 80 (“YES” at step 296). In this modification, there are also decorative images, etc., printed by the printer of the creator 2. Consequently, unless the scrapbook server 5 is informed of which parts are to be printed by the printer of the creator 2, it will so happen that parts identical with parts such as decorative images to be printed by the printer of the creator 2 are delivered to the residence of the creator 2. For this reason, identification data (e.g., part IDs included in the layer data as mentioned above) of parts to be printed by the printer of the creator 2 also is transmitted from the computer 1 of the creator 2 to the scrapbook server 5 (step 297).

In this modification, the manner in which overlapping portions of decorative images are printed can be selected in order to conserve toner (ink) in the printer of creator 2 (it goes without saying that the same holds true for portions that overlap the image of the paper mount) (step 298).

FIG. 40 illustrates an example of a window 320 for selecting how to print overlapping portions. In a case where the print select button 112 has been clicked and a decorative image or the like has been selected for printing by the printer of creator 2, the window 320 appears on the display screen of the display unit of creator 2 if the quit button 111 is clicked in the manner described above.

An example of overlapping images is being displayed in an area 321 on the left side of window 320. A portion of a decorative image 323 is overlapped by a decorative image 322. How printing is to be performed in this case is selected by the creator 2. A first output example area 325 is defined in an upper area on the right side of the window 320, and a second output example area 329 is defined in a lower area on the right side of the window 320. An example in which selected decorative images 322 and 324 are printed as is (standard print) is being displayed in the first output example area 325. The right side of the first output example area 325 is provided with check box 326 clicked by the creator 2 in a case where standard printing is to be performed. Displayed in the second output example area 329 is an example (conserve toner) in which the upper image 322 of the selected images is printed as is, whereas with regard to a lower image 327, an overlapped portion 327A is not printed but the edge thereof is printed. The right side of the second output example area 329 is provided with a check box 328 clicked by the creator 2 in a case where conserve-toner printing is to be performed.

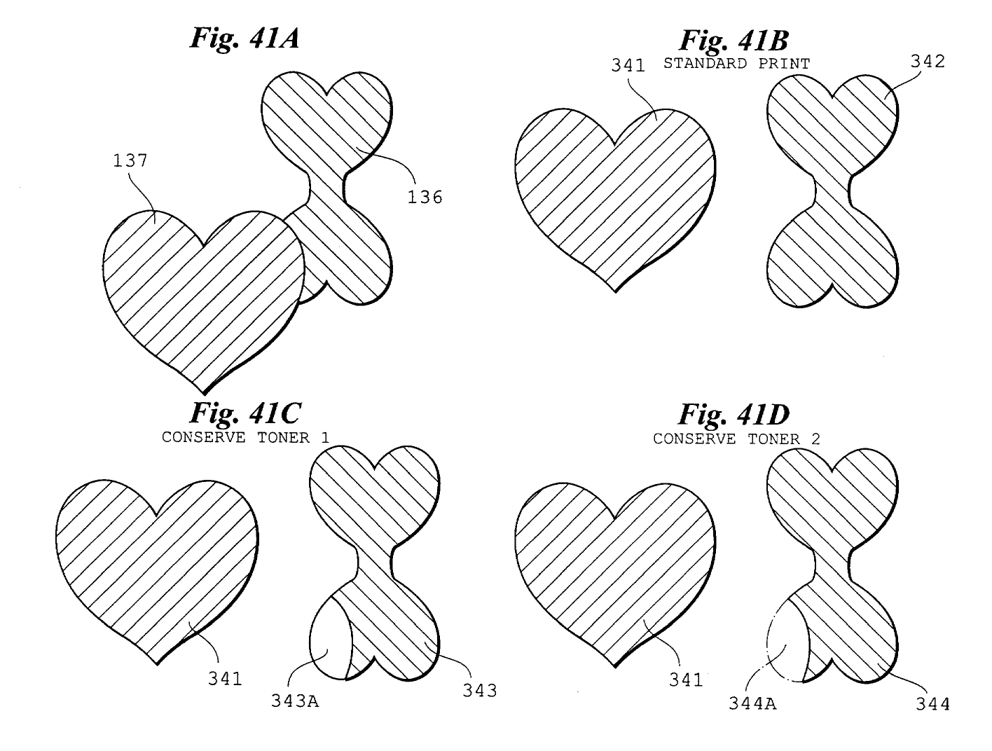

In a case where decorative image 137 is placed to overlap a portion of decorative image 136 in the manner described above, as illustrated in FIG. 41A, part 341 corresponding to decorative image 136 and part 342 corresponding to decorative image 137 are printed independently of each other in the case of standard printing, as illustrated in FIG. 41B. In the case of conserve-toner printing, as illustrated in FIG. 41C, part 341 corresponding to decorative image 136 is printed in conformity with the selected decorative image 136, as mentioned above. However, the part corresponding to decorative image 137 is not printed in conformity with the selected decorative image 137. Portion 343A that is overlapped is not printed; only the edge thereof is printed. Further, as illustrated in FIG. 41D, it may be so arranged that the edge also is not displayed with regard overlapped portion 344A. In either case, the area printed is reduced. This makes it possible to conserve toner (ink).

Furthermore, the window 320 at the lower right thereof includes a button 330A on which the characters “NEXT” are displayed, and a button 330B on which the characters “BACK” are displayed. Clicking the button 330A causes display of a window for selecting the method of placing a part image to be printed by the printer of the creator 2, as will be described next. The window shown in FIG. 38 is displayed by clicking the button 330B.

With reference again to FIG. 36, the method of placing a part image is selected by the creator 2 (step 299). If automatic placement has been selected (step 300), placement position is decided by automatic placement processing (step 301), which is described later. The position of a part image decided by automatic placement processing can be corrected by the creator 2 (step 302). In a case where the creator 2 places the part image (step 300), the placement position of the part image is decided by a designation from the creator 2 (step 303). The part image is printed at the placement position decided (step 304).

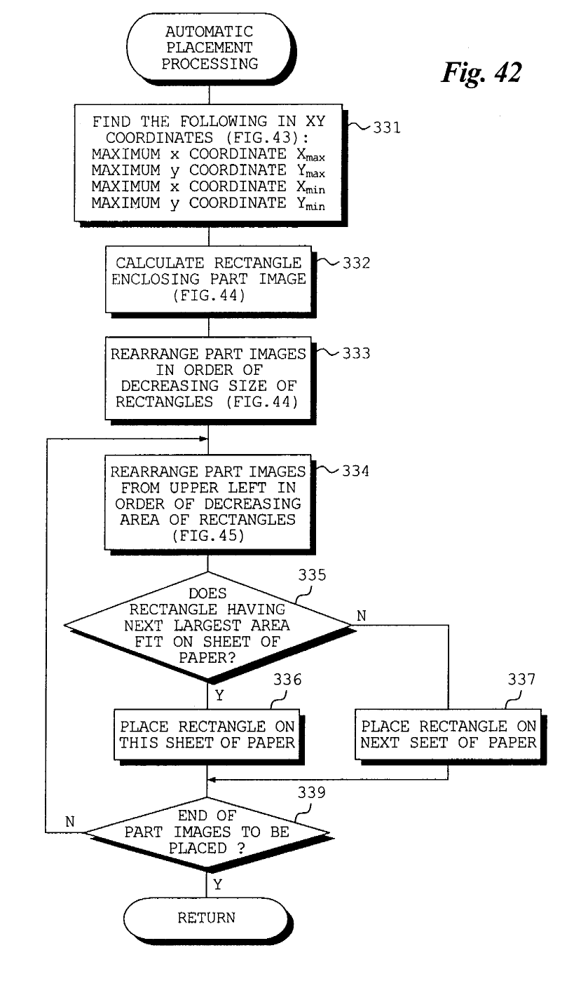

FIG. 42 is a flowchart illustrating processing for automatic placement of parts (the processing of step 301 in FIG. 36). Although part image 138 is taken as an example in the example illustrated next, processing is similar for other part images as well.

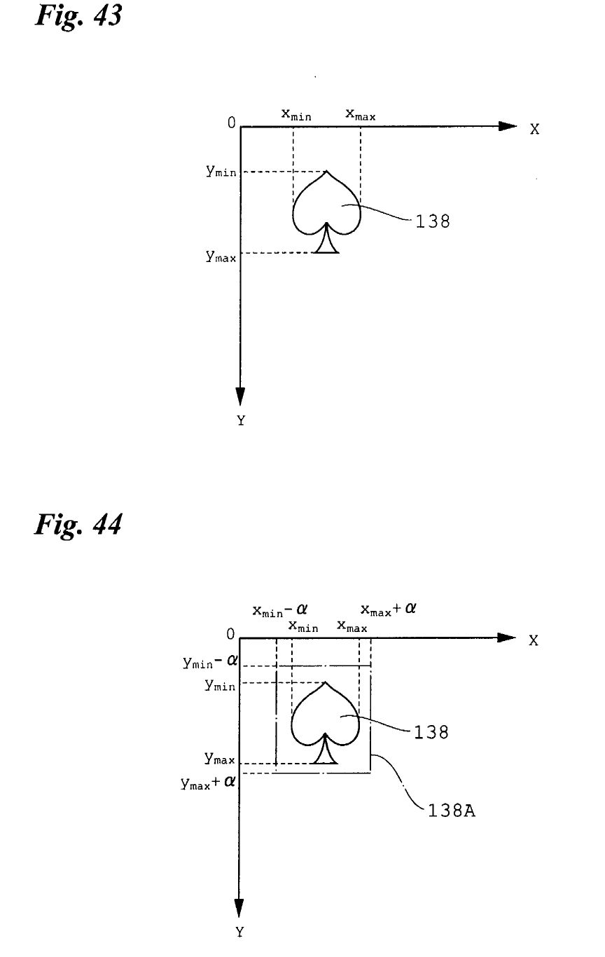

First, considering an XY coordinate system in which the point at the upper-left corner of the image 132 of the paper mount is adopted as the origin O, as illustrated in FIG. 43, maximum x and y coordinates xₘₐₓ and yₘₐₓ, respectively, and minimum x and y coordinates xₘᵢₙ and yₘᵢₙ, respectively, of part image 138 in this XY coordinate system are calculated (step 331).

Next, a rectangle 138A enclosing the part image 138 is calculated (step 332), as illustrated in FIG. 44. The rectangle 138A is defined by an area obtained by adding an allowance width α to the maximum x and y coordinates xₘₐₓ and yₘₐₓ, respectively, of the part image 138 and subtracting the allowance width a from the minimum x and y coordinates xₘᵢₙ and yₘᵢₙ, respectively. By virtue of the allowance width α, part images will not touch one another when the part images are arranged for printing, and it becomes easier for the creator 2 to cut out the part images.

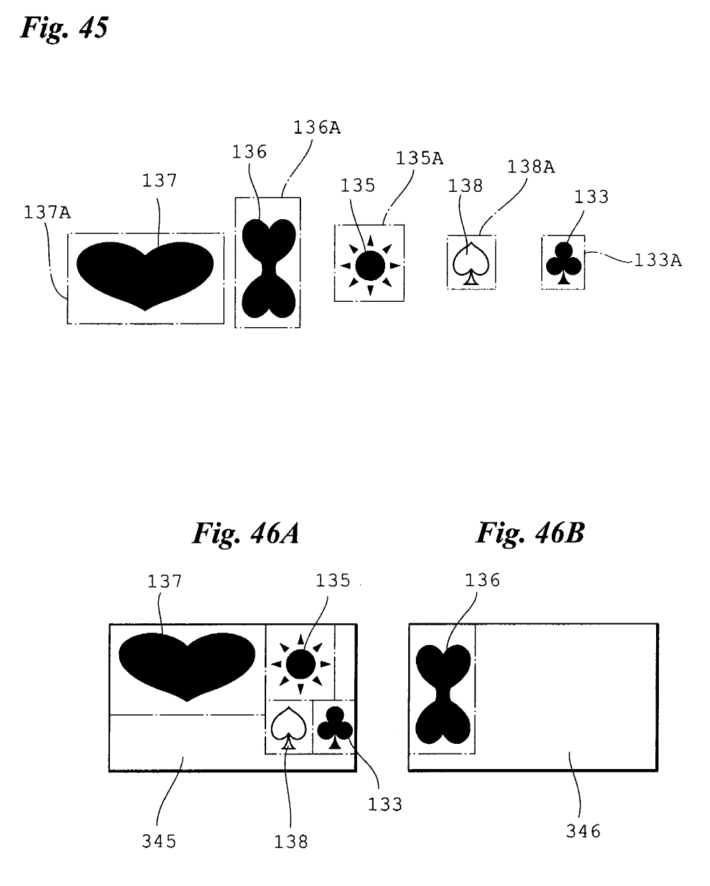

When rectangles enclosing part images are calculated for all part images, the part images are rearranged in order of decreasing size of the rectangles, as illustrated in FIG. 45 (step 333). In the example shown in FIG. 45, the sizes of rectangles 137A, 136A, 135A, 138A, 133A decrease in the order of the part images 137, 136, 135, 138 and 133.

Next, as illustrated in FIG. 46A, the part images are arranged in such a manner that they will be printed in order starting from the upper left of a sheet of paper (virtual paper in the memory of the computer of creator 2) 345 in order of decreasing area of the rectangles (step 334). In a case where part image 136 having a rectangle whose area is the next largest of the arranged part images will fit on the sheet of paper (“YES” at step 335), the part image (rectangle) is placed on the sheet of paper (step 336). In a case where part image 136 having a rectangle whose area is the next largest of the arranged part images will not fit on the sheet of paper (“NO” at step 335), the part image (rectangle) is placed on the next sheet of paper 346 (step 337). For example, in a case where part image 137 is placed on sheet of paper 345 and part image 136 will not fit on sheet of paper 345 (FIG. 46B), part image 136 is placed on the next sheet of paper 346. The part images 135, 138, 133 that follow are placed on the paper sheet 345 in the order mentioned if they will fit. Thus, the part images can be placed on paper automatically and printed. The results of such placement are displayed on the display screen of the display unit of creator 2 and then the part images are dragged, thereby allowing the creator 2 to correct placement position. Part images can be placed automatically in such a manner that the paper can be utilized effectively.

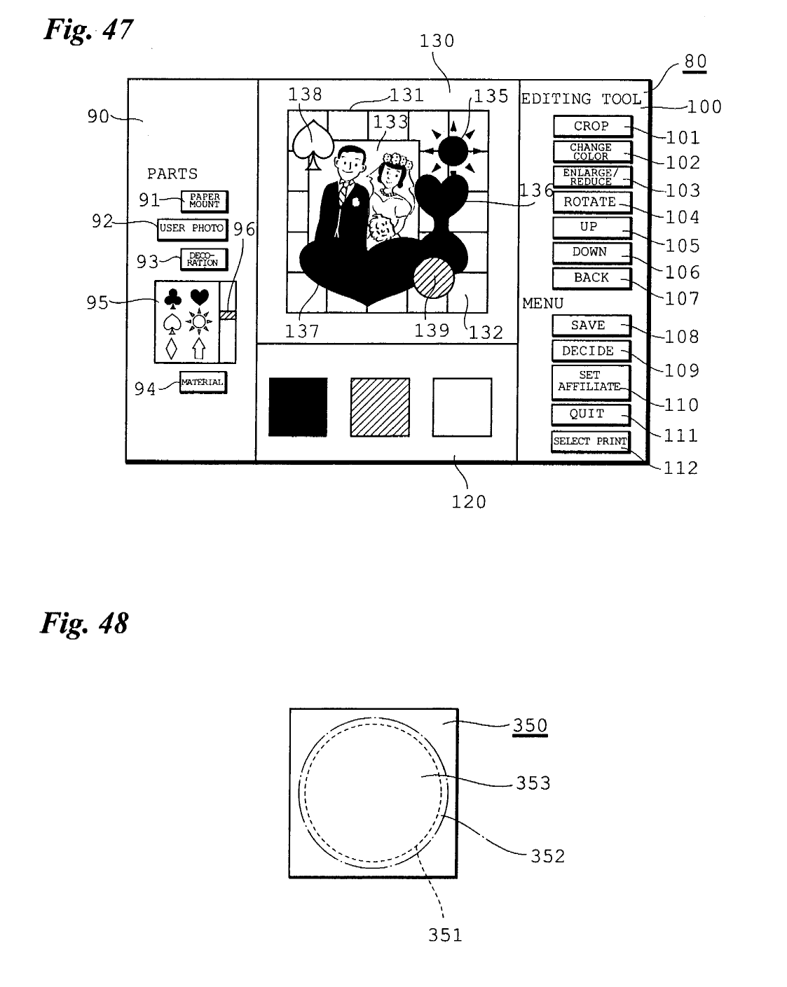

FIGS. 47 to 54 illustrate another modification. According to this modification, a positioning line is printed on a part underlying an upper part superimposed directly thereon, the positioning line indicating the placement position of the upper part. Further, in a case where a part is cut out, the cutting line of the part also is printed.

FIG. 47 illustrates an example of the window 80 displayed on the display screen of the display unit of the computer of creator 2. Portions in FIG. 47 identical with those in FIGS. 12 and 37, etc., are designated by like reference characters and need not be described again.

In the window 80 illustrated in FIG. 47, a decorative image 139 has been selected anew. Although the decorative image 139 is circular, it has been cut from a rectangular decorative image. A portion of the circular decorative image 139 overlaps a portion of the decorative image 136 and another portion overlaps a portion of the decorative image 137. In this modification, positioning lines indicating the placement position of the decorative image 139 on the decorative images 136 and 137 are printed on the parts corresponding to the decorative images 136 and 137 in such a manner that the placement position of the decorative image 139 can be ascertained. In a case where there is a part that is overlapped from above, it goes without saying that a positioning line indicating the placement position of the upper part is printed also on this underlying part and not only on parts corresponding to the decorative images 136 and 137. Further, since the circular decorative image 139 has been cut from a rectangular decorative image, a circular cutting line is printed on the part corresponding to the rectangular decorative image in such a manner that a circular part will be obtained.

FIG. 48 illustrates an example of a part corresponding to a rectangular decorative image.

As mentioned above, the decorative image 139 is obtained by cutting it out from a rectangular decorative image. A part 350 corresponding to the rectangular decorative image, therefore, also is rectangular in shape.

A cutting line 352 has been printed on the part 350, as mentioned above. The cutting line 352 is printed so as to be situated slightly outside of a position 351 corresponding to the portion cut out by the creator 2 in the window 80. (For example, the cutting line 352 is situated 1 mm on the outer side of position 351, namely on the side that is cut.) By using scissors to cut away the part slightly inwardly of the cutting line 352 in such a manner that the cutting line 352 printed on the part 350 will be concealed, an actual part 353 corresponding to what has been cut out by the creator 2 in window 80 is obtained.

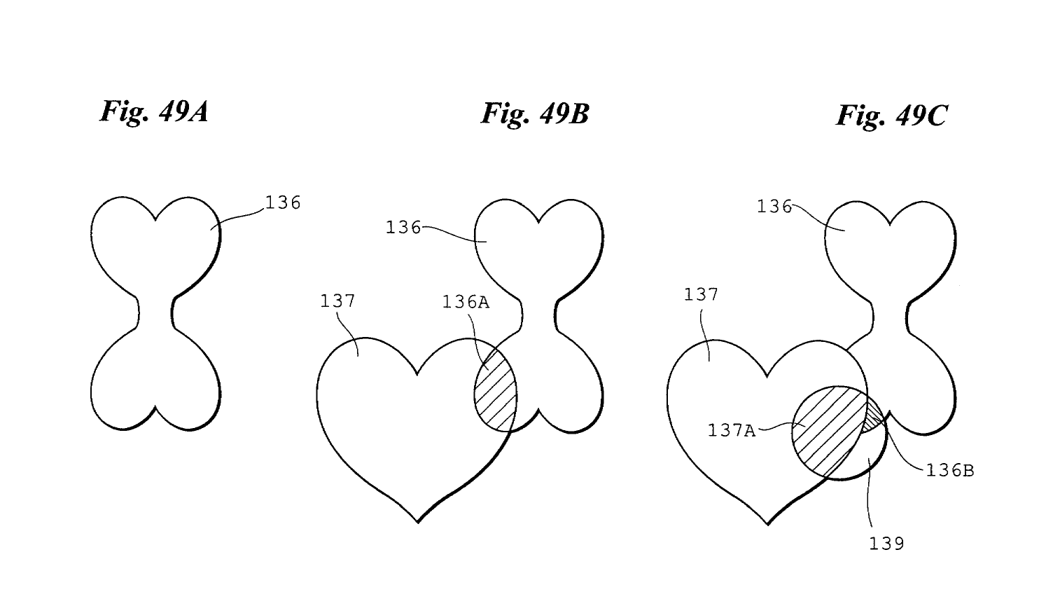

FIGS. 49A to 49C illustrate the relationship among the placement positions of decorative images 136, 137 and 139 in FIG. 47.

As illustrated in FIG. 49A, first the decorative image 136 is selected and positioned. Next, as illustrated in FIG. 49B, it is assumed that the decorative image 137 has been positioned so as to overlap one portion 136A (indicated by hatching) of the decorative image 136. Further, as illustrated in FIG. 49C, it is assumed that the decorative image 139 has been positioned so as to overlap one portion 136B of decorative image 136 and one portion 137A of decorative image 137 (both portions are indicated by hatching).

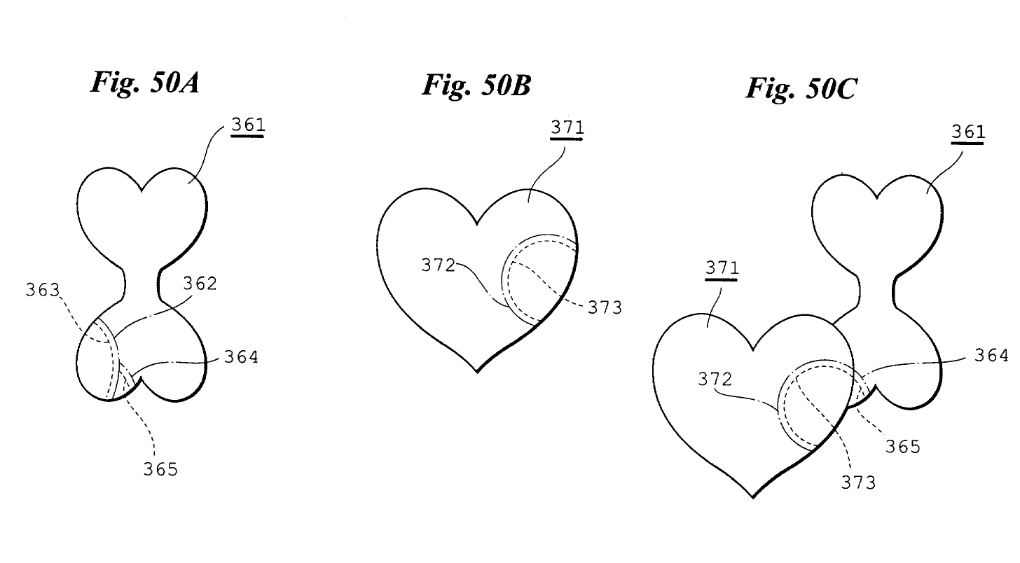

FIGS. 50A to 50C show examples of actual parts. FIG. 50A is a part 361 corresponding to decorative image 136, FIG. 50B is a part 371 corresponding to decorative image 137, and FIG. 50C illustrates the part 361 and the part 371 in superimposed form.

As shown in FIG. 50A, a first positioning line 363 has been printed on the part 361. The first positioning line 363 indicates the placement position of the part 371. By placing the part 371 along the first positioning line 363, the part 371 can be placed on the part 361 in a positional relationship identical with that of the decorative image 137 placed on the decorative image 136 in the simulation, as illustrated in FIG. 49B. The first positioning line 363 has been printed on the inner side of a boundary line 362 that corresponds to the boundary of the decorative image 137 placed on the decorative image 136 (namely on the side on which the overlaid upper part is placed) in the simulation illustrated in FIG. 49B. By placing the part 371 on the part 361 in such a manner that the first positioning line 363 is concealed, the part 371 comes to be placed on the part 361 in the positional relationship that conforms to the simulation. Although the boundary line 362 is illustrated in order to facilitate understanding, it goes without saying that the boundary line 362 has not been printed on the part.

Furthermore, a second positioning line 365 has been printed on the part 361. The second positioning line 365 indicates the placement position of the part 361 that corresponds to the decorative image 139.

As shown in FIG. 50B, a positioning line 373 has been printed on the part 371. The positioning line 373 indicates the placement position of the part that corresponds to the decorative image 139. The positioning line 373 also has been printed on the inner side of a boundary line 372 that corresponds to the boundary between images 137 and 139 shown in FIG. 49C. By placing the part corresponding to the decorative image 139 on the part 371 so as to conceal the positioning line 373, the part corresponding to the decorative image 139 comes to be placed on the part 371 in conformity with the simulation. The boundary line 372 is not printed on the actual part 371.

When the part 371 is placed along the first positioning line 363 of part 361, as shown in FIG. 50C, the second positioning line 365 that has been printed on the part 361 and the positioning line 373 that has been printed on the part 371 form a continuous line. By placing the part corresponding to the decorative image 139 along the second positioning line 365 and positioning line 373, the part shown in FIG. 49C can be placed. In this case also the lines 365 and 373 have been printed on the inner sides of the boundary line 372 corresponding to the boundary between decorative image 136 and decorative image 139 and a boundary line 364 corresponding to the boundary between decorative image 136 and decorative image 139, respectively. Therefore, by placing the part corresponding to decorative image 139 so as to conceal the positioning lines 373 and 365, the actual part can be placed in conformity with the simulation.

In the example described above, the cutting line is printed on the outer side of the cutting line in the simulation. However, it may be so arranged that the cutting line is printed on the underside of a part. It may be so arranged that in a case where the cutting line is printed on the underside of a part, the cutting line is printed on the underside in conformity with the simulation without offsetting it to the outer side of the position that corresponds to the simulation.

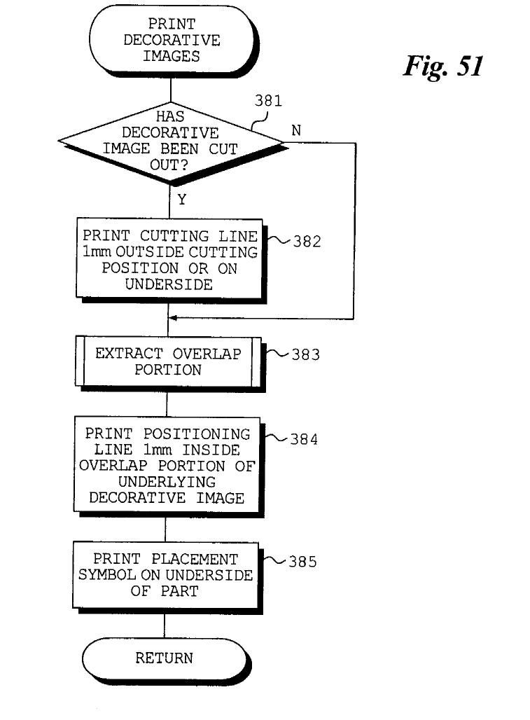

FIG. 51 is a flowchart illustrating processing for printing a decorative image (part) on which a positioning line and cutting line are printed in the manner described above.

Whether a decorative image has been cut out by the creator 2 is determined (step 381). If the decorative image has been cut out (“YES” at step 381), then a cutting line is printed 1 mm outside the cutting position in the simulation, or on the underside of the part, as described above (step 382).

The overlap portion of the decorative image is extracted as described above (step 383). A positioning line is printed 1 mm inside the extracted overlap portion (step 384). A placement symbol is printed on the underside of the part (step 385).

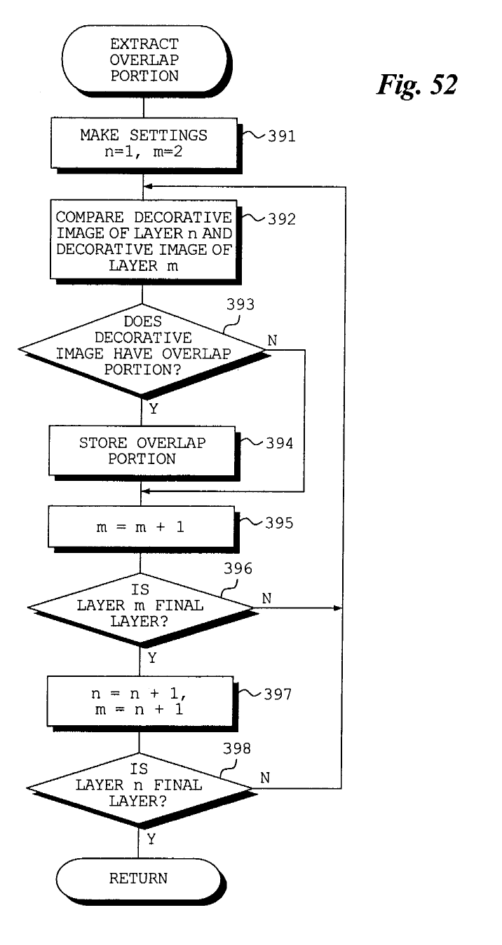

FIG. 52 is a flowchart illustrating processing for extracting an overlap portion (the processing at step 383 in FIG. 51).

First, a first layer variable n is set to 1 and a second layer variable m is set to 2 (step 391). A decorative image of a layer having the layer number of the first layer variable n and a decorative image of a layer having the layer number of the second layer variable m are compared (step 392). If a decorative image has an overlap portion (“YES” at step 393), the overlap portion is stored (step 394). The second layer variable m is incremented (step 395) and the processing of steps 392 to 395 is repeated until a layer having the layer number of the second layer variable m is the final layer (the uppermost layer) (“NO” at step 396).

If the layer having the layer number of the second layer variable m becomes the final layer (“YES” at step 396), then overlap between the decorative image of a layer having the layer number of the first layer variable n and the decorative image of the layer superimposed on this underlying layer is detected. Accordingly, the first layer variable n is incremented and the second layer variable m becomes a value obtained by adding 1 to the first layer variable n (step 397). The processing of steps 392 to 397 is repeated until the first layer variable n becomes the final layer number (step 398). Overlap between the decorative image contained in the second layer from the bottom excluding the layer of the paper mount and the decorative image contained in the layer that exists above the second layer is detected and stored.

In accordance with overlap portions that have been stored in order starting from the underlying layer, positioning lines of parts that will directly overlap each other are printed in the manner illustrated in FIGS. 50A to 50C. Positioning lines where there is no direct overlap are not printed. For example, in a case where part 371 is superimposed on part 361, the first positioning line 363 is printed on part 361, as illustrated in FIG. 50A. In a case where part 361 overlapped by part 371 and the part of decorative image 139 superimposed on part 371 overlap, the second positioning line 365 is printed on the part 361 directly overlapped by the part of decorative image 139, and a positioning line is not printed at the portion of part 361 that is not directly overlapped by the part of decorative image 139. By executing overlap along positioning lines in order from the underlying parts, the positioning lines become those that make it possible to superimpose parts in conformity with the simulation.

In the foregoing embodiment, a positioning line is not printed on a paper mount. However, it may be so arranged that positioning line is printed on the paper mount as well. In order to arrange it so that a positioning line is printed on a paper mount, it will suffice if the first and second layer variables n and m are set to 0 and 1, respectively, at step 391 described earlier.

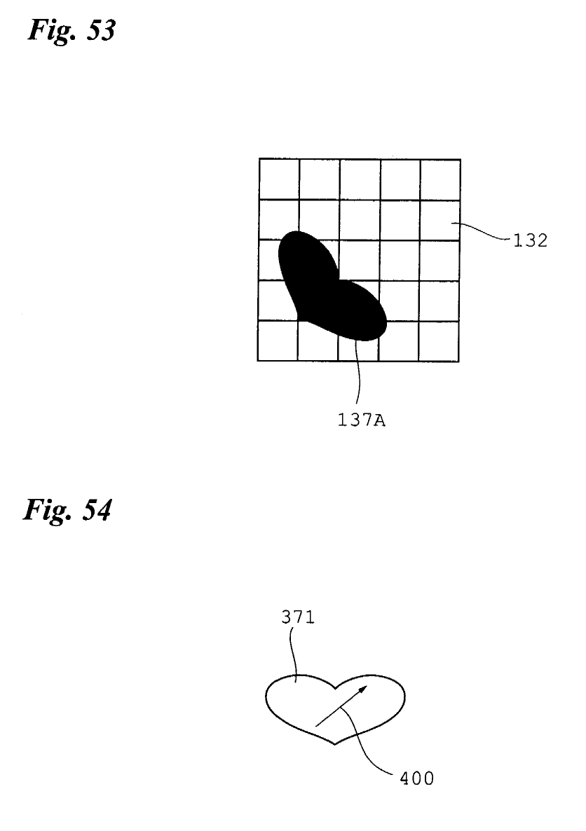

FIGS. 53 and 54 are useful in describing a placement symbol printed on the underside of a part (this corresponds to the processing at step 385 in FIG. 51).

In a case where a decorative image or the like has been placed obliquely in a simulation, the orientation in which the image is to be placed may not be known when the part is delivered to the residence of the creator 2. The placement symbol is for the purpose of informing the creator 2 of the correct orientation.

FIG. 53 illustrates the relationship between the image of a paper mount and a decorative image displayed on the display screen of the display unit of the creator in the simulation. FIG. 54 illustrates the underside of a part on which the symbol has been printed.

As illustrated in FIG. 53, a selected decorative image 137B has been disposed so as to be tilted clockwise to the right in the simulation. In the case of such a simulation, the part of the decorative image 137B cannot be placed on the paper mount in conformity with the simulation unless the orientation of the part of the decorative image 137B is known. In this embodiment, therefore, a symbol 400 indicating the orientation is printed on the underside of decorative image 371 in the manner illustrated in FIG. 54. The symbol 400 is an arrow (as long as the correct orientation can be determined, the symbol need not necessarily be an arrow). The part 371 is affixed to the paper mount in such a manner that the direction indicated by the arrow symbol 400 points upward. This makes it possible to affix the actual part 371 to the paper mount in an orientation identical with that in the simulation.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for controlling printing of part images of a scrapbook, comprising:
a selecting device for selecting the image of a part of a scrapbook created by affixing a part such as a photograph to a part such as a paper mount;
a display control device for controlling a display unit in such a manner that the part image selected by said selecting device is placed and displayed at a position designated by a user;
a quit command input device for inputting a quit command to quit a scrapbook creating simulation carried out by repeating the selection of part images by said selecting device and the display of part images by said display control device; and
a printer control device, which is responsive to input of the quit command from said quit command input device, for controlling a printer so as to print part images, which have been selected by said selecting device, close together on paper in such a manner that these part images will not overlap one another.

2. The apparatus according to claim 1, wherein said printer control device controls the printer, in response to input of the quit command from said quit command input device, so as to print the part images upon deciding placement positions close together on the paper in such a manner that rectangles enclosing the part images that have been selected by said selecting device will not overlap one another, the placement positions being decided in order of decreasing size of the rectangles of the part images.

3. The apparatus according to claim 1, wherein said printer control device halts the printing of an overlap portion of an underlying part image placed and displayed below one part image that has been selected by said selecting device, or halt the printing of the interior of the overlap portion and print an outline.

4. A method of controlling an apparatus for controlling printing of part images of a scrapbook, the method comprising the steps of:
selecting, by a selecting device, the image of a part of a scrapbook created by affixing a part such as a photograph to a part such as a paper mount;
controlling, by a display control device, a display unit in such a manner that the part image selected by the selecting device is placed and displayed at a position designated by a user;
inputting, by a quit command device, a quit command to quit a scrapbook creating simulation carried out by repeating the selection of part images and the display of selected part images; and
in response to input of the quit command, controlling, by a printer control device, a printer so as to print part images, which have been selected by the selecting device, close together on paper in such a manner that these part images will not overlap one another.

5. A program for controlling an apparatus, which controls printing of part images of a scrapbook, so as to:
select the image of a part of a scrapbook created by affixing a part such as a photograph to a part such as a paper mount;
control a display unit in such a manner that the part image selected is placed and displayed at a position designated by a user;
input a quit command to quit a scrapbook creating simulation carried out by repeating the selection of part images and the display of part images selected; and
in responsive to input of the quit command, control a printer so as to print selected part images close together on paper in such a manner that these part images will not overlap one another.

6. A recording medium on which the program set forth in claim 5 has been stored.
